(19) United States
(12) Patent Application Publication
(10) Pub. No.: US 2025/0310976 A1
(43) Pub. Date: Oct. 2, 2025

(54) SIDELINK RESOURCE ALLOCATION CONSIDERATIONS FOR ENERGY HARVESTING DEVICES

(71) Applicant: QUALCOMM Incorporated, San Diego, CA (US)

(72) Inventors: Ahmed ELSHAFIE, San Diego, CA (US); Seyedkianoush HOSSEINI, San Diego, CA (US); Yuchul KIM, San Diego, CA (US); Zhikun WU, Beijing (CN); Linhai HE, San Diego, CA (US); Huilin XU, Temecula, CA (US)

(21) Appl. No.: 18/864,493

(22) PCT Filed: Jul. 22, 2022
(86) PCT No.: PCT/CN2022/107295

§ 371 Date: Nov. 8, 2024

(51) Int. Cl. H04W 72/40; H02J 50/00; H04L 1/1812; H04L 1/1829; H04W 72/25

(52) U.S. Cl. CPC H04W 72/40; H02J 50/001; H04L 1/1812; H04L 1/1854; H04W 72/25

(57) ABSTRACT

Aspects are provided which allow for increases in or lengthening of periods between reserved or configured resources for sidelink data transmissions and retransmissions by a time offset accommodating EH devices. An Rx UE or Tx UE transmits information indicating that its data transmissions or data receptions are based on harvested energy at the respective UE. The Rx UE receives a configuration indicating a first resource for a sidelink data transmission and a second resource for a sidelink data retransmission. The Tx UE transmits sidelink data in the first resource and retransmits the sidelink data in another resource. The Rx UE receives the retransmitted sidelink data in a third resource at a time offset with respect to the second resource, where the time offset is based on the information. Thus, the likelihood of successful reception or transmission of sidelink data involving EH devices may be increased.

### BACKGROUND

### Technical Field

The present disclosure generally relates to wireless communication and wireless communication systems, and more particularly, to a wireless communication system including sidelink or direct communication between user equipment (UEs), where at least one of the UEs harvests energy for wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

For example, some aspects of wireless communication include direct communication between devices, such as device-to-device (D2D), vehicle-to-everything (V2X), and the like. There exists a need for further improvements in such direct communication between devices. Improvements related to direct communication between devices may be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, a computer program, and an apparatus are provided. The apparatus may be a UE, such as a receiving UE (Rx UE) in sidelink communication. The Rx UE receives a configuration indicating a first resource for a sidelink data transmission and a second resource for a sidelink data retransmission. The Rx UE transmits information indicating that data transmissions or data receptions of the apparatus are based on harvested energy at the apparatus. The Rx UE receives sidelink data in a third resource at a time offset with respect to the second resource, where the time offset is based on the information.

In another aspect of the disclosure, a method, a computer-readable medium, a computer program, and an apparatus are provided. The apparatus may again be a UE, such as a transmitting UE (Tx UE) in sidelink communication. The Tx UE receives information indicating that data transmissions or data receptions of a UE (a Rx UE) are based on harvested energy at the UE (the Rx UE). The Tx UE transmits sidelink data in a first resource configured for a sidelink data transmission. The Tx UE further transmits the sidelink data in a second resource at a time offset with respect to a third resource configured for a sidelink data retransmission, where the time offset is based on the information.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 illustrate example aspects of a sidelink slot structure.

FIG. 4 is a diagram illustrating an example of a first device and a second device involved in wireless communication based, e.g., on sidelink communication.

FIG. 5 is a diagram illustrating an example of a UE which harvests energy from a radio frequency (RF) signal received from another UE.

FIG. 6 is a diagram illustrating an example of a resource pool including resource reservations for a sidelink data transmission.

FIG. 7 is a diagram illustrating an example of a slot carrying sidelink data from a Tx UE to a Rx UE.

FIG. 8 is a diagram illustrating an example of a resource allocation in a physical sidelink feedback channel that is associated with a physical sidelink shared channel.

FIG. 9 is a diagram illustrating an example of configured grant occasions for sidelink data transmissions and sidelink data retransmissions.

FIG. 10 is a diagram illustrating an example of a resource pool including sidelink data resources that are offset in time with respect to configured resources for sidelink data retransmissions based on energy harvesting at a UE.

FIGS. 11A-11B are diagrams respectively illustrating examples of a resource pool including sidelink data resources which are offset at different times with respect to a configured resource for a sidelink data retransmission.

FIG. 12 is a diagram illustrating an example of a resource pool including sidelink data resources which are offset at different times for transmission and reception with respect to a configured resource for a sidelink data retransmission.

FIG. 13 is a call flow diagram between a Tx UE, an Rx UE, and a base station.

FIG. 14 is a flowchart of a method of wireless communication at a Rx UE.

FIG. 15 is a flowchart of a method of wireless communication at a Tx UE.

FIG. 16 is a diagram illustrating an example of a hardware implementation for an example apparatus.

### DETAILED DESCRIPTION

The detailed description set forth below in connection with the appended drawings is intended as a description of various exemplary configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

An energy harvesting (EH) device may opportunistically harvest energy from the environment, such as solar, heat or other ambient radiation, and the device may apply this harvested energy for later use (e.g., storing data or backscatter communication). EH devices may include UEs such as radio frequency identification (RFID) tags, Reduced Capability (RedCap) UEs (e.g., UEs with reduced power capability), passive internet of things (IoT) devices (e.g., RFID tags without access to an external power source), semi-passive or semi-active IoT devices (e.g., RFID tags connected to an external battery), active IoT devices, or other UEs. EH devices may also be grouped into an EH class, which may be defined by an amount of minimum (at least) or default (average or expected) harvested or collected energy of the device within an interval of time (e.g., a charging rate), a discharging rate (resulting from power consumption due to, e.g., battery leakage, signal processing, filtering, signal reception and decoding, signal preparation and encoding, monitoring one or more signals of different type(s) [data, control, reference signals], and the like), and a maximum energy storage unit size of the device (e.g., a maximum battery capacity). Moreover, an EH class may be defined by at least a minimum time gap between two transmissions, a minimum time gap between two receptions, or a combination of the foregoing, at the device. EH devices may have different EH classes, and thus have different charging rates, discharging rates, battery capacities, minimum time gaps, etc.

EH devices may transmit data to, or receive data from, other UEs in sidelink communication. Typically, a transmitting (Tx) UE initially transmits sidelink data to a receiving (Rx) UE in a reserved or configured resource. The Tx UE subsequently receives hybrid automatic repeat request (HARQ) feedback from the Rx UE. If the HARQ feedback is a non-acknowledgment (NACK), the Tx UE may retransmit the sidelink data in the subsequent retransmission (ReTx) occasion; otherwise, if the HARQ feedback is an acknowledgment (ACK), the Tx UE may subsequently transmit new sidelink data in the subsequent Tx occasion. If multiple ReTx occasions are configured per Tx occasion (up to a maximum configured quantity of occasions), the Tx UE may retransmit the sidelink data in multiple ReTx occasions in response to receiving NACKs in prior respective occasions. Otherwise, the Tx UE may not utilize the ReTx occasion (or cease utilizing ReTx occasions) if the Tx UE receives an ACK in a prior occasion.

For Tx UEs or Rx UEs which are EH devices, the typically configured periodicity between a sidelink transmission and a retransmission may be insufficient, since an EH device may require additional time for battery charging or otherwise for harvesting sufficient ambient energy for sidelink communication than other UEs. For example, with typical periodicities, an Rx UE or a Tx UE which relies on harvested energy for sidelink communication may not have sufficient energy charged up at the time of a configured ReTx occasion, preventing successful decoding or encoding of the sidelink data retransmission. Therefore, it would be helpful for the typically configured periodicity between transmissions and retransmissions to be frozen or otherwise increased or lengthened to accommodate EH devices.

To this end, aspects of the present disclosure allow a base station or a UE in sidelink communication (e.g., an Rx UE or a Tx UE) to increase or lengthen a period between reserved or configured resources for sidelink data transmissions and retransmissions by a time offset or a quantity of slots z. For instance, to allow for additional time for energy harvesting, the time between Tx occasions and ReTx occasions and/or the time between successive ReTx occasions may be increased by z slots. This time offset z may be applied to reserved or configured resources for sidelink data which a base station may schedule or activate in mode 1 resource allocation, in a dynamic grant, or in a configured grant, or which a UE may obtain in a mode 2 resource allocation. Thus, the likelihood of successful reception or transmission of sidelink data involving EH devices may be increased.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

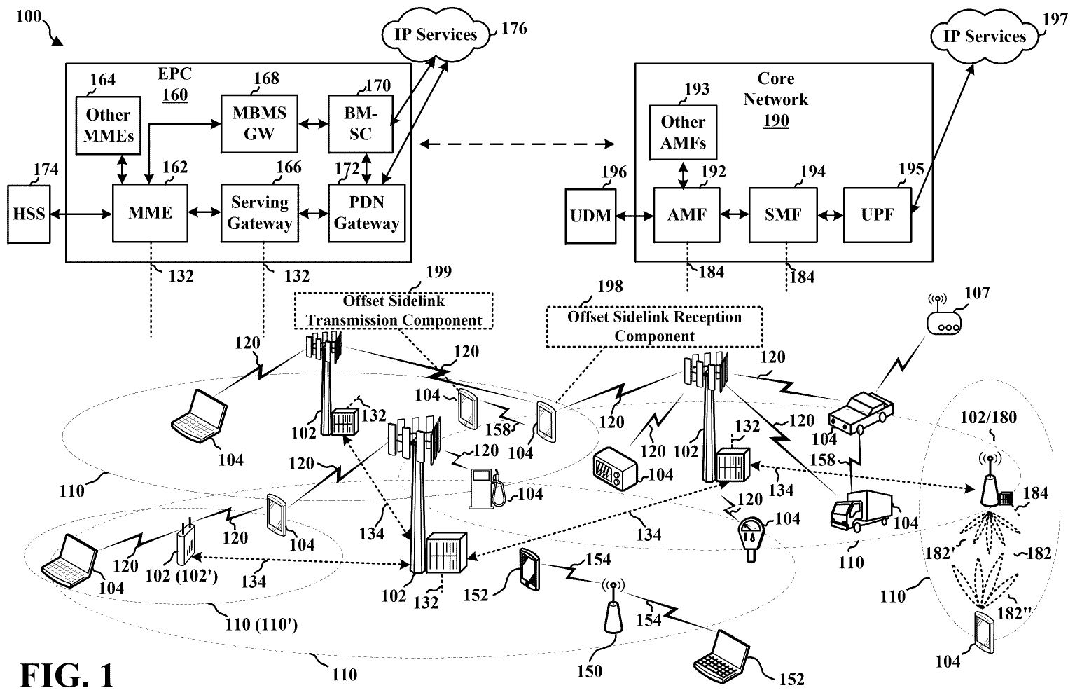

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR. Sidelink may in general refer to wireless communications between wireless devices, such as D2D communications, without relaying their data via the network.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHZ” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although beamformed signals are illustrated between UE 104 and base station 102/180, aspects of beamforming may similarly be applied by UE 104 or RSU 107 to communicate with another UE 104 or RSU 107, such as based on V2X, V2V, or D2D communication.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

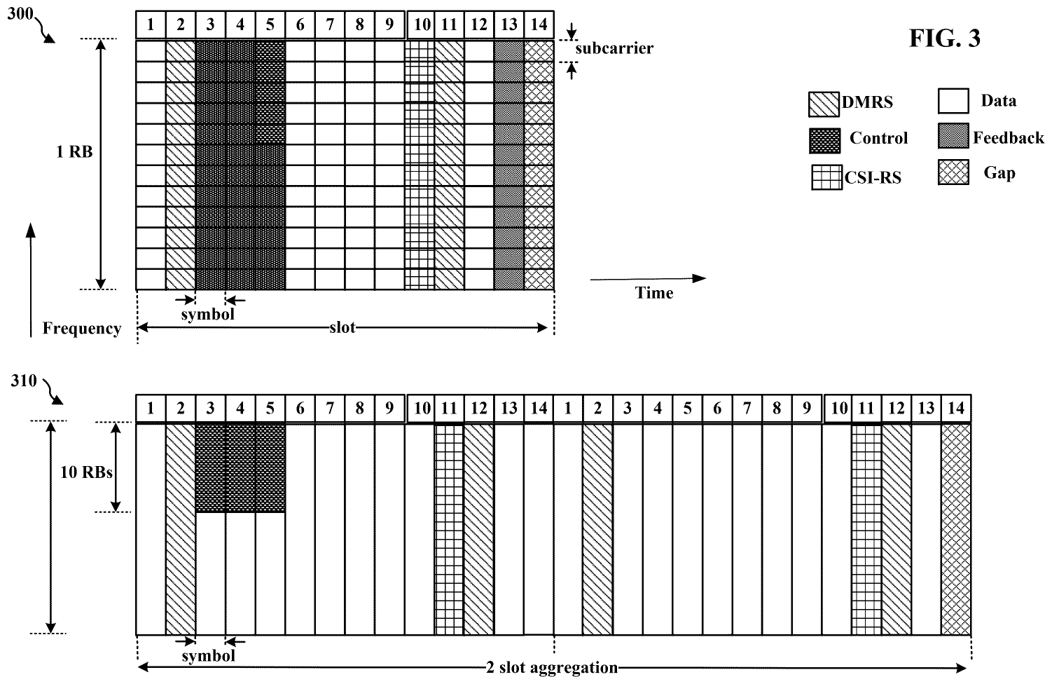

Some wireless communication networks may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), and/or a combination thereof and/or with other devices, which can be collectively referred to as vehicle-to-anything (V2X) communications. Referring again to FIG. 1, in certain aspects, a UE 104, e.g., a transmitting Vehicle User Equipment (VUE) or other UE, may be configured to transmit messages directly to another UE 104. The communication may be based on V2V/V2X/V2I or other D2D communication, such as Proximity Services (ProSe), etc. Communication based on V2V, V2X, V2I, and/or D2D may also be transmitted and received by other transmitting and receiving devices, such as Road Side Unit (RSU) 107, etc. Aspects of the communication may be based on PC5 or sidelink communication, e.g., as described in connection with the example in FIG. 3.

Although the present disclosure may focus on NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies. The concepts and various aspects described herein may also be applicable to vehicle-to-everything (V2X) or other similar areas, such as D2D communication, IoT communication, Industrial IoT (IIoT) communication, and/or other standards/protocols for communication in wireless/access networks. Additionally or alternatively, the concepts and various aspects described herein may be of particular applicability to one or more specific areas, such as vehicle-to-pedestrian (V2P) communication, pedestrian-to-vehicle (P2V) communication, vehicle-to-infrastructure (V2I) communication, and/or other frameworks/models for communication in wireless/access networks.

Referring again to FIG. 1, in certain aspects, the UE 104 may be a Rx UE including an offset sidelink reception component 198. The offset sidelink reception component 198 may be configured to receive a configuration indicating a first resource for a sidelink data transmission and a second resource for a sidelink data retransmission, to transmit information indicating that data transmissions or data receptions of the UE are based on harvested energy at the UE, and to receive sidelink data in a third resource at a time offset with respect to the second resource, where the time offset is based on the information.

Still referring to FIG. 1, in certain aspects, the UE 104 may be a Tx UE including an offset sidelink transmission component 199. The offset sidelink transmission component 199 may be configured to receive information indicating that data transmissions or data receptions of a UE (a Rx UE) are based on harvested energy at the UE (the Rx UE), to transmit sidelink data in a first resource configured for a sidelink data transmission, and to transmit the sidelink data in a second resource at a time offset with respect to a third resource configured for a sidelink data retransmission, where the time offset is based on the information.

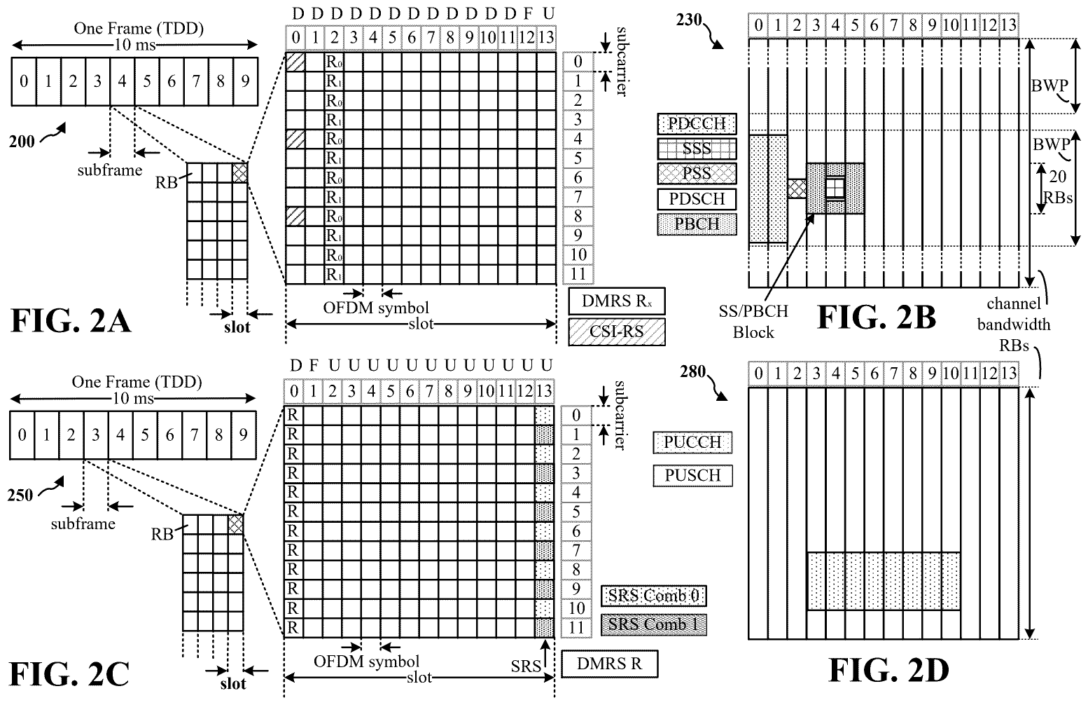

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 24 slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2A, some of the REs may carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS may be used by a UE 104 to determine subframe/symbol timing and a physical layer identity. A secondary synchronization signal (SSS) may be within symbol 4 of particular subframes of a frame. The SSS may be used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

FIG. 3 illustrates example diagrams 300 and 310 illustrating example slot structures that may be used for wireless communication between UE 104 and UE 104′, e.g., for sidelink communication. The slot structure may be within a 5G/NR frame structure. Although the following description may be focused on 5G NR, the concepts described herein may be applicable to other similar areas, such as LTE, LTE-A, CDMA, GSM, and other wireless technologies. This is merely one example, and other wireless communication technologies may have a different frame structure and/or different channels. A frame (10 ms) may be divided into 10 equally sized subframes (1 ms). Each subframe may include one or more time slots. Subframes may also include mini-slots, which may include, for example, 7, 4, or 2 symbols. Each slot may include 7 or 14 symbols, depending on the slot configuration. For slot configuration 0, each slot may include 14 symbols, and for slot configuration 1, each slot may include 7 symbols. Diagram 300 illustrates a single slot transmission, e.g., which may correspond to a 0.5 ms transmission time interval (TTI). Diagram 310 illustrates an example two-slot aggregation, e.g., an aggregation of two 0.5 ms TTIs. Diagram 300 illustrates a single RB, whereas diagram 310 illustrates N RBs. In diagram 310, 10 RBs being used for control is merely one example. The number of RBs may differ.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 3, some of the REs may comprise control information, e.g., along with demodulation RS (DMRS). FIG. 3 also illustrates that symbol(s) may comprise CSI-RS. The symbols in FIG. 3 that are indicated for DMRS or CSI-RS indicate that the symbol comprises DMRS or CSI-RS REs. Such symbols may also comprise REs that include data. For example, if a number of ports for DMRS or CSI-RS is 1 and a comb-2 pattern is used for DMRS/CSI-RS, then half of the REs may comprise the RS and the other half of the REs may comprise data. A CSI-RS resource may start at any symbol of a slot, and may occupy 1, 2, or 4 symbols depending on a configured number of ports. CSI-RS can be periodic, semi-persistent, or aperiodic (e.g., based on DCI triggering). For time/frequency tracking, CSI-RS may be either periodic or aperiodic. CSI-RS may be transmitted in busts of two or four symbols that are spread across one or two slots. The control information may comprise Sidelink Control Information (SCI). At least one symbol may be used for feedback, as described herein. A symbol prior to and/or after the feedback may be used for turnaround between reception of data and transmission of the feedback. Although symbol 12 is illustrated for data, it may instead be a gap symbol to enable turnaround for feedback in symbol 13. Another symbol, e.g., at the end of the slot may be used as a gap. The gap enables a device to switch from operating as a transmitting device to prepare to operate as a receiving device, e.g., in the following slot. Data may be transmitted in the remaining REs, as illustrated. The data may comprise the data message described herein. The position of any of the SCI, feedback, and LBT symbols may be different than the example illustrated in FIG. 3. Multiple slots may be aggregated together. FIG. 3 also illustrates an example aggregation of two slot. The aggregated number of slots may also be larger than two. When slots are aggregated, the symbols used for feedback and/or a gap symbol may be different that for a single slot. While feedback is not illustrated for the aggregated example, symbol(s) in a multiple slot aggregation may also be allocated for feedback, as illustrated in the one slot example.

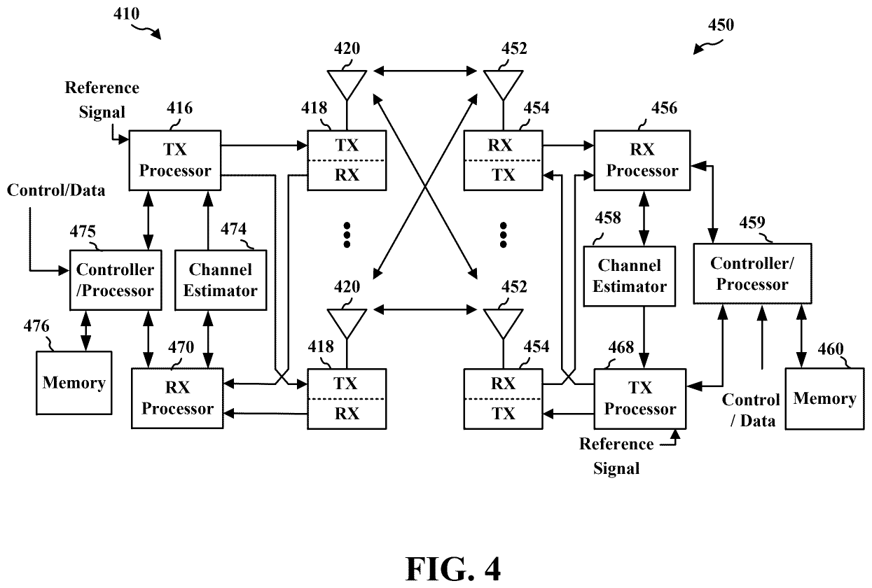

FIG. 4 is a block diagram of a first wireless communication device 410 in communication with a second wireless communication device 450, e.g., via V2V/V2X/D2D communication or in an access network. The device 410 may comprise a transmitting device communicating with a receiving device, e.g., device 450, via V2V/V2X/D2D communication. The communication may be based, e.g., on sidelink. The transmitting device 410 may comprise a UE, a base station, an RSU, etc. The receiving device may comprise a UE, a base station, an RSU, etc.

IP packets from the EPC 160 may be provided to a controller/processor 475. The controller/processor 475 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 416 and the receive (RX) processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 474 may be used to determine the coding and modulation scheme, as well as for spatial processing. The channel estimate may be derived from a reference signal and/or channel condition feedback transmitted by the device 450. Each spatial stream may then be provided to a different antenna 420 via a separate transmitter 418TX. Each transmitter 418TX may modulate an RF carrier with a respective spatial stream for transmission.

At the device 450, each receiver 454RX receives a signal through its respective antenna 452. Each receiver 454RX recovers information modulated onto an RF carrier and provides the information to the receive (RX) processor 456. The TX processor 468 and the RX processor 456 implement layer 1 functionality associated with various signal processing functions. The RX processor 456 may perform spatial processing on the information to recover any spatial streams destined for the device 450. If multiple spatial streams are destined for the device 450, they may be combined by the RX processor 456 into a single OFDM symbol stream. The RX processor 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the device 410. These soft decisions may be based on channel estimates computed by the channel estimator 458. The soft decisions are then decoded and deinterleaved to recover the data and control signals that were originally transmitted by the device 410 on the physical channel. The data and control signals are then provided to the controller/processor 459, which implements layer 3 and layer 2 functionality. The controller/processor 459 can be associated with a memory 460 that stores program codes and data. The memory 460 may be referred to as a computer-readable medium. The controller/processor 459 may provide demultiplexing between transport and logical channels, packet reassembly, deciphering, header decompression, and/or control signal processing to recover IP packets from the EPC 160. The controller/processor 459 may be also responsible for error detection using an ACK and/or NACK protocol to support HARQ operations.

Similar to the functionality described in connection with the DL transmission by the device 410, the controller/processor 459 may provide RRC layer functionality associated with system information (e.g., MIB, SIBs) acquisition, RRC connections, and measurement reporting; PDCP layer functionality associated with header compression/decompression, and/or security (ciphering, deciphering, integrity protection, integrity verification); RLC layer functionality associated with the transfer of upper layer PDUs, error correction through ARQ, concatenation, segmentation, and/or reassembly of RLC SDUs, re-segmentation of RLC data PDUs, and/or reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and/or logical channel prioritization.

Channel estimates derived by a channel estimator 458 from a reference signal or feedback transmitted by device 410 may be used by the TX processor 468 to select the appropriate coding and modulation schemes, and to facilitate spatial processing. The spatial streams generated by the TX processor 468 may be provided to different antenna 452 via separate transmitters 454TX. Each transmitter 454TX may modulate an RF carrier with a respective spatial stream for transmission.

The transmission may be processed at the device 410 in a manner similar to that described in connection with the receiver function at the device 450. Each receiver 418RX receives a signal through its respective antenna 420. Each receiver 418RX recovers information modulated onto an RF carrier and provides the information to a RX processor 470.

The controller/processor 475 can be associated with a memory 476 that stores program codes and data. The memory 476 may be referred to as a computer-readable medium. The controller/processor 475 provides demultiplexing between transport and logical channels, packet reassembly, deciphering, header decompression, control signal processing to recover IP packets from the device 450. IP packets from the controller/processor 475 may be provided to the EPC 160. The controller/processor 475 may be also responsible for error detection using an ACK and/or NACK protocol to support HARQ operations.

At least one of the TX processor 468, the RX processor 456, and the controller/processor 459 may be configured to perform aspects in connection with offset sidelink reception component 198 of FIG. 1.

At least one of the TX processor 416, the RX processor 470, and the controller/processor 475 may be configured to perform aspects in connection with offset sidelink transmission component 199 of FIG. 1.

EH technology has acquired a large amount of interest in the context of passive IoT. An EH device may opportunistically harvest energy from the environment, such as solar, heat or other ambient radiation, and the device may apply the energy for later use (e.g., storing data or backscatter communication). Protocol enhancements have been considered to support EH device operation on intermittently available energy harvested from the environment. For example, enhancements have considered variations in the expected amount of harvested energy and traffic experienced by an EH device, or considered EH devices which may not sustain continuous reception or transmission for a long amount of time.

EH devices have become prevalent for multiple reasons. One reason is that EH devices may result in power savings. For example, RFID tags that are applied to various goods in a warehouse for position tracking purposes generally do not include batteries and instead harvest energy from the environment. As a result of the energy harvesting capability of these RFID tags, the associated energy costs of the warehouse may be reduced. Moreover, maintenance of EH devices such as RFID tags may be greatly reduced, if no batteries have to be charged or replaced. Another reason relates to spectrum efficiency. For example, in 5G and similar technologies where spectrum efficiency is important, UEs tend to overlap in spectrum usage and therefore experience interference. However, as EH devices typically are implemented in a localized environment such as a warehouse, this interference may be less of an issue. For instance, the localization of EH devices in one warehouse may prevent these devices from overlapping in spectrum usage with other EH devices in another warehouse, and thus the EH devices of one warehouse may utilize the same frequencies as those of another warehouse without interference. Even in the mmW environment where high frequency bands are very close to one another, EH devices may occupy the same frequency spectrum in different environments without one application overlapping with another, and therefore spectrum efficiency may be achieved in mmW bands using EH devices.

Additionally, EH devices may result in lower network costs. For example, when EH devices communicating with a base station, UE, or other RF source are deployed in a localized situational environment, the RF source may also be small and localized, saving network costs. For instance, a base station acting as RF source to EH devices in a warehouse may not include a direct connection to the core network, and instead may be connected to an external base station which communicates with the core network. Thus, the base station in the warehouse may be cost effectively configured to only provide RF signals to EH devices in the warehouse. The EH devices may obtain the signals from the base station, and utilizing energy harvested from those signals, store data carried in those signals or redirect those signals modulated with their own data to an RFID reader (e.g., a reduced capability UE or other UE). In the latter case, the RFID reader may receive the modulated signals and detect the presence of the EH devices accordingly.

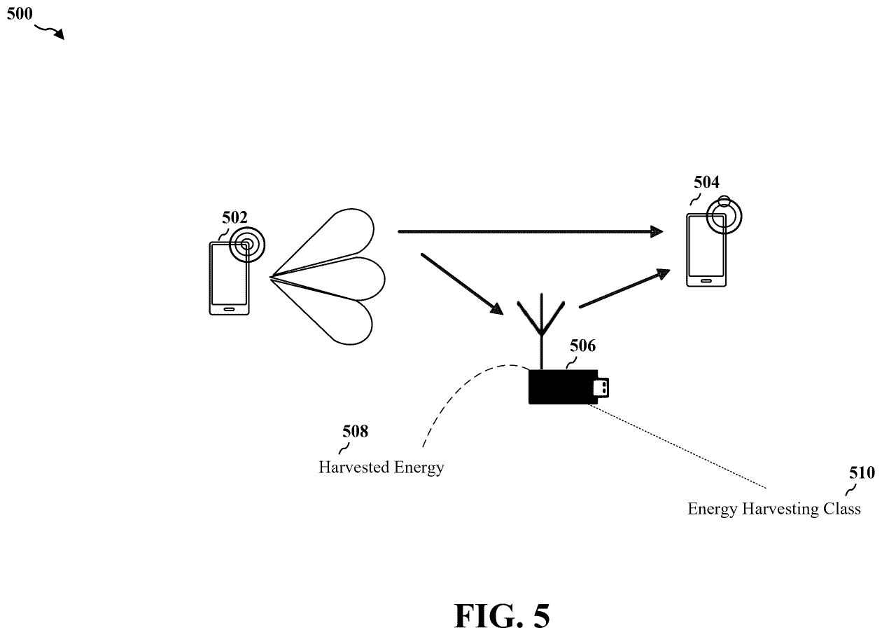

FIG. 5 illustrates an example 500 of a first UE 502 (e.g., an RF source) communicating directly with a second UE 504 (e.g., an RF reader) and a third UE 506 (e.g., an EH device), where the third UE 506 applies harvested energy 508 to store data from the first UE 502 or backscatter (redirect) data from the first UE 502 to the second UE 504. EH devices such as third UE 506 may be grouped into an EH class 510, which may be defined by an amount of harvested or collected energy of the device within an interval of time (e.g., a charging rate), a discharging rate, and a maximum energy storage unit size of the device (e.g., a maximum battery capacity). Moreover, an EH class may be defined by at least a minimum time gap between two transmissions, a minimum time gap between two receptions, or a combination of the foregoing, at the device. EH devices may have different EH classes, and thus have different charging rates, discharging rates, battery capacities, minimum time gaps, etc.

EH devices such as third UE 506 may include UEs such as RFID tags, RedCap UEs (e.g., UEs with reduced power capability), passive IoT devices (e.g., RFID tags without access to an external power source), semi-passive or semi-active IoT devices (e.g., RFID tags connected to an external battery), active IoT devices, or other UEs. These devices may collect energy from one or more of a variety of energy sources, including but not limited to, RF, solar energy, thermal energy, laser energy, light energy, or other ambient energy. For instance, harvested energy 508 may include energy that the third UE 506 obtained from a power source, from an ambient RF signal from an RF source or other source device (e.g., first UE 502), from a solar cell which harvests solar energy from the environment, from a rechargeable battery which may be charged from energy harvested from an RF signal or other energy source, from a combination of the foregoing, or the like. Following energy harvesting, EH devices may apply this energy to store or backscatter data from an RF source such as first UE 502. For example, third UE 506 may store its own data (e.g., position tracking data, etc.) and, using the collected energy from a received ambient RF signal, the third UE 506 may modulate or otherwise modify the ambient RF signal with its data to form a backscattered signal to a reader such as second UE 504 for various purposes (e.g., position tracking, inventorying, etc.). Thus, EH devices may include power-consuming RF components such as analog to digital converters, mixers, and oscillators which the devices may apply in order to modulate or otherwise modify an RF signal with stored data for backscatter communication.

EH devices such as third UE 506 may also transmit data to, or receive data from, other UEs (e.g., first UE 502 and second UE 504) in sidelink communication. Generally, in sidelink communications, a Tx UE (e.g., first wireless communication device 410) initially achieves sidelink synchronization with a Rx UE (e.g., second wireless communication device 450). Following synchronization, the Tx UE may obtain an allocation of time-frequency resources, e.g., one or more slots, RBs, or subchannels in a resource pool, in which to transmit sidelink data to the Rx UE. Typically, the resource allocation may be scheduled by a base station in downlink control information (DCI) (in a mode 1 resource allocation), or the resource allocation may be determined through a sensing procedure conducted autonomously by the Tx UE (in a mode 2 resource allocation).

When a sidelink resource allocation is scheduled by a base station, the base station may configure the resources in a dynamic grant (e.g., in DCI) or a configured grant (CG). A CG may be a CG Type 1 or a CG Type 2. A CG Type 1 is a resource grant the base station provides to the UE via an RRC configuration. For example, the base station may configure the UE with a set of periodic resources or initial Tx occasions which the UE may apply for an initial sidelink data transmission (e.g., a new transport block), and the UE may retransmit a given transport block in up to two future resources or ReTx occasions (e.g., up to a maximum of three scheduled resources per transport block). A CG Type 2 is a resource grant the base station provides to the UE via PDCCH (or other layer 3 signaling). For instance, the base station may configure the initial Tx occasions associated with a resource grant via an RRC configuration, but activate or deactivate the resource grant via DCI in PDCCH. The base station may also schedule the ReTx occasions associated with the resource grant in DCI. Thus, the UE may transmit data in initial Tx occasions and ReTx occasions associated with that configured grant when the grant is active.

After determining the resources (e.g., from a dynamic grant, CG, or autonomously), the Tx UE may send sidelink control information (SCI) including the resource allocation in a physical sidelink control channel (PSCCH) to the Rx UE. The Tx UE may transmit the SCI in two stages, including a first-stage SCI (also referred to as SCI-1) carried on PSCCH, and a second-stage SCI (also referred to as SCI-2) carried on a physical sidelink shared channel (PSSCH). SCI-1 may contain information about the resource allocation, while SCI-2 may carry information for identifying and decoding the sidelink data. The Tx UE may transmit the sidelink data in the PSSCH to the Rx UE in the allocated resources.

Upon receiving the sidelink transmission, the Rx UE may attempt to blindly decode the PSCCH in all of the allocated subchannels of the resource pool. If the Rx UE successfully decodes the PSCCH, the UE may also attempt to decode the PSSCH scheduled by the PSCCH for the sidelink data. Depending on the decoding result, the Rx UE may provide hybrid automatic repeat request (HARQ) acknowledgment/negative acknowledgment (ACK/NACK) feedback to the Tx UE in a physical sidelink feedback channel (PSFCH). For example, if the Rx UE failed to decode the sidelink data, the UE may provide NACK to the Tx UE, while if the Rx UE successfully decoded the sidelink data, the UE may provide ACK to the Tx UE. If the Tx UE receives NACK from the Rx UE, the Tx UE may retransmit the sidelink data in configured or scheduled resources for retransmission (ReTx). Otherwise, if the Tx UE receives ACK from the Rx UE, the Tx UE may transmit new data to the Rx UE, or transmit data to a different Rx UE.

When the Tx UE transmits SCI-1, the SCI-1 may indicate a number and location of resource reservations for the PSSCH. For instance, SCI-1 may indicate a frequency domain resource allocation (FDRA) and a time domain resource allocation (TDRA) indicating the sub-channel(s) and slot(s) which are reserved for the sidelink data transmission, and a resource reservation period which informs nearby UEs of the resources being reserved for initial sidelink data transmissions or sidelink data retransmissions. The FDRA and TDRA may each be a field of SCI-1, where each field may include a different numbers of bits depending on the number of configured reservations for the sidelink transmission. For example, in FDRA, the number of bits in the FDRA field may be

$$⌈ log \frac{{N}_{subchannel}^{SL} ( {N}_{subchannel}^{SL} + 1 )}{2} ⌉$$

or some other number for two reservations, and

$$⌈ log \frac{{N}_{subchannel}^{SL} ( {N}_{subchannel}^{SL} + 1 ) ( 2 {N}_{subchannel}^{SL} + 1 )}{6} ⌉$$

or some other number for three reservations. The value of the bits in the FDRA may indicate the sub-channel(s) and RBs in the resource pool which are allocated for the sidelink data. Similarly, in TDRA, the number of bits may be 5 or some other number for two reservations, and 9 or some other number for three reservations. The value of the bits in the TDRA indicates the slot(s) and symbols in the resource pool which are allocated for the sidelink data. The resource reservation period may include a given quantity of bits depending on a quantity of allowed periods.

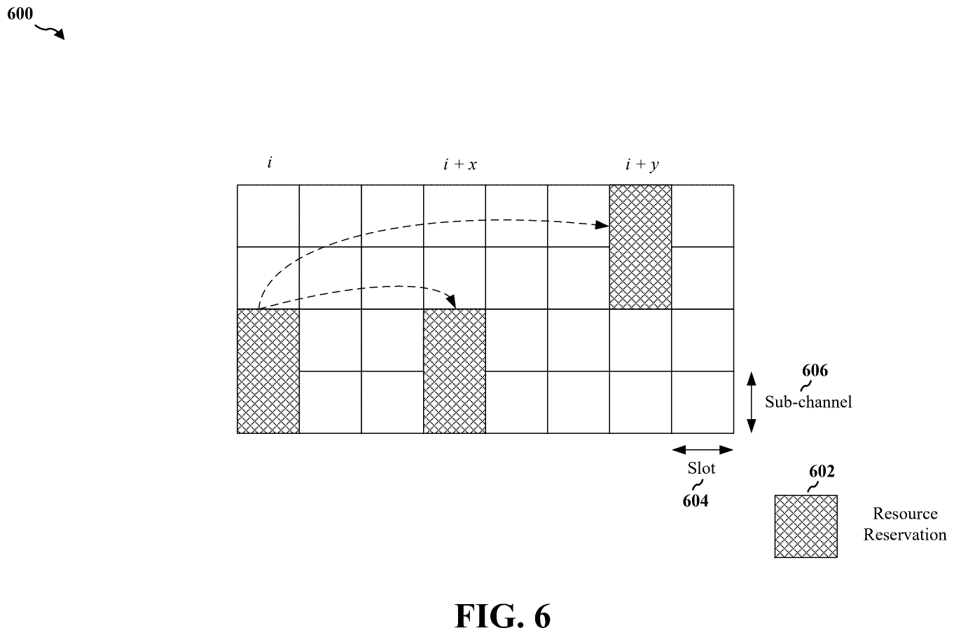

FIG. 6 illustrates an example of a resource pool 600 including resource reservations 602 for a sidelink data transmission. Each resource reservation 602 may include a slot 604 and one or more subchannels 606. For example, the base station or Tx UE may configure a resource pool with three resource reservations such as illustrated in FIG. 6, with each resource reservation spanning one slot and two subchannels. The base station may configure the resource pool 600 and resource reservations 602 in DCI (in a mode 1 resource allocation), or the Tx UE may determine the resource pool 600 and resource reservations 602 autonomously (in a mode 2 resource allocation). The Tx UE may also indicate the resource pool 600 and resource reservations 602 in SCI-1 to a Rx UE. For instance, the Tx UE may transmit PSCCH including SCI-1 in slot i indicating that resource reservations for PSSCH are present in slots i, i+x, and i+y and each span a number of subcarriers j, with i, x, y, and j being configured values such as indicated for example in the following Table 1. These values are merely examples; the resource pool may be configured with a different number of resource reservations spanning a different number of slot(s) and subchannel(s) in other examples.

TABLE 1
Reservations Signaled by an SCI in slot i

| Reservation | # of Sub-channels | Slot |
|---|---|---|
| 1 | j | i |
| 2 | j | i + x: 0 < x ≤ 31 |
| 3 | j | i + y: x < y ≤ 31 |

Thus, the Tx UE may transmit SCI-1 to indicate to the Rx UE the allocated resources for the PSSCH. Additionally, the Tx UE may transmit SCI-2 to indicate other information for the Rx UE to decode the PSSCH. For instance, SCI-2 may be front-loaded in PSSCH to indicate at least the following information: a HARQ process ID for the PSSCH whose number of bits depend on a number of HARQ processes, a new data indicator (NDI) having a fixed number of bits (e.g., 1 bit), a redundancy version identifier (RV-ID) having a fixed number of bits (e.g., 2 bits), a source identifier of the Tx UE having a fixed number of bits (e.g., 8 bits), a destination identifier of the Rx UE having a fixed number of bits (e.g., 16 bits), and a HARQ enable/disable flag having a fixed number of bits (e.g., 1 bit). The Rx UE and other sidelink UEs may determine this information to identify which UE(s) are the Rx UEs, as well as to allow the Rx UE(s) to successfully decode the PSSCH in the allocated resources.

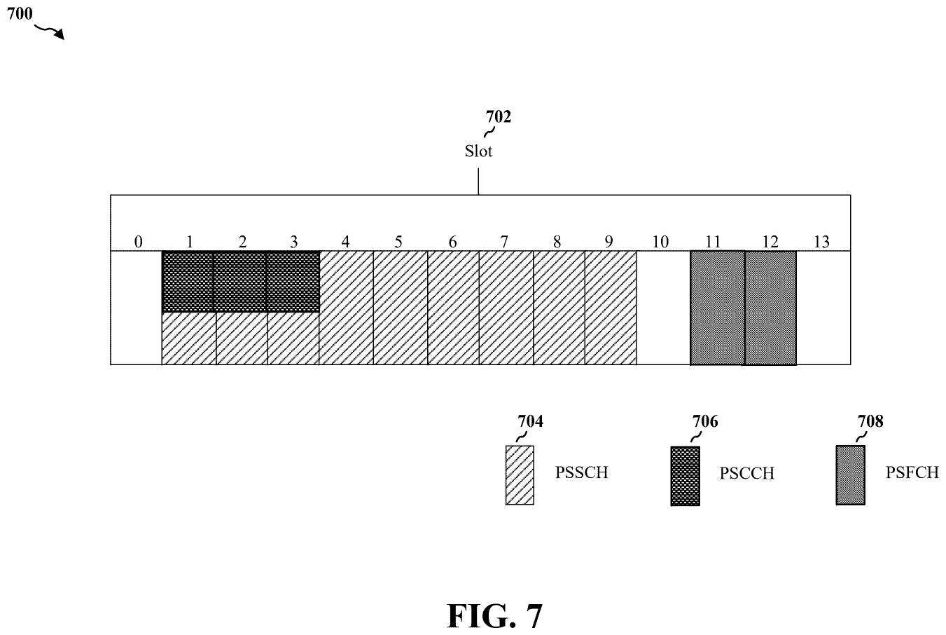

FIG. 7 illustrates an example 700 of a slot 702 carrying sidelink data in PSSCH 704 from a Tx UE to a Rx UE. In addition to the PSSCH 704, slot 702 may include a PSCCH 706 carrying SCI-1, and a PSFCH 708 for carrying HARQ feedback (ACK/NACK) from the Rx UE. The slot may also include other data besides the information carried in PSSCH 704, PSCCH 706, and PSFCH 708, including, for example, DMRS and guard periods. The PSSCH may occupy at least 1 sub-channel and contain SCI-2. The PSCCH 706 may be multiplexed with the PSSCH 704 in various time-frequency resources within slot 702. The PSCCH may be configured (or pre-configured) to occupy 10, 12, 15, 20, 25, or other number of PRBs in a single subchannel. The PSCCH duration may also be configured (or pre-configured) to be 2, 3, or other number of symbols. Moreover, a subchannel may occupy 10, 15, 20, 25, 50, 75, 100, or other number of PRBs. The number of subchannels in a resource pool (RP) may be anywhere including or between 1 to 27 subchannels or other number. The PSCCH size may be fixed for a resource pool, taking anywhere including or between 10% to 100% of a sub-channel or other range, during a first 2, 3, or other number of symbols, depending on the configuration of the PSCCH. Thus, while FIG. 7 illustrates a particular example configuration for PSSCH, PSCCH, and PSFCH, in other examples, PSSCH, PSCCH, or PSFCH may be configured differently such as previously described.

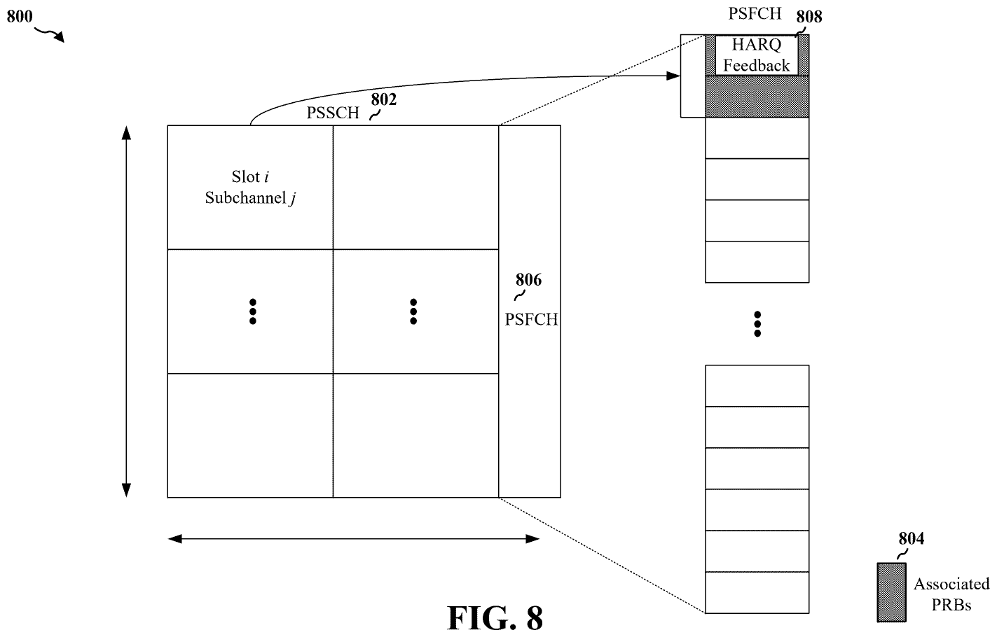

FIG. 8 illustrates an example 800 of a configured mapping between a PSSCH 802 and a resource 804 (e.g., one or more PRBs) in PSFCH 806 based at least in part on information in SCI. For instance, the location of resource 804 may be based on a starting sub-channel (e.g., sub-channel j) of the PSSCH (e.g., as indicated by parameter sl-PSFCH-CandidateResourceType being configured as type startSubCH, or other names) or a number of subchannels in a PSSCH (e.g., as indicated by parameter sl-PSFCH-CandidateResourceType being configured as type allocSubCH, or other names). Moreover, the location of resource 804 may be based on the slot (e.g., slot i) containing PSSCH, the source identifier of the Tx UE, and the destination identifier of the Rx UE. The PSFCH resource may also be determined based on a configured PSFCH periodicity (in number of slots) in a resource pool (e.g., as indicated by parameter periodPSFCHresource or another name), a minimum time gap (in number of slots) between a last slot of the PSSCH reception and a first slot including PSFCH resources (e.g., as indicated by parameter MinTimeGapPSFCH or another name), a set of PRBs in a resource pool for PSFCH transmission (e.g., as indicated by parameter rbSetPSFCH or another name), a number of sub-channels for the resource pool (e.g., as indicated by parameter numSubchannel or another name), a number of PSSCH slots associated with a PSFCH slot, and other parameters. Thus, in the example of FIG. 8, a given slot i and sub-channel j in PSSCH 802 may be associated with resource 804 in PSFCH 806 including two PRBs, and the Rx UE may provide HARQ feedback 808 in one of the PRBs to the Tx UE.

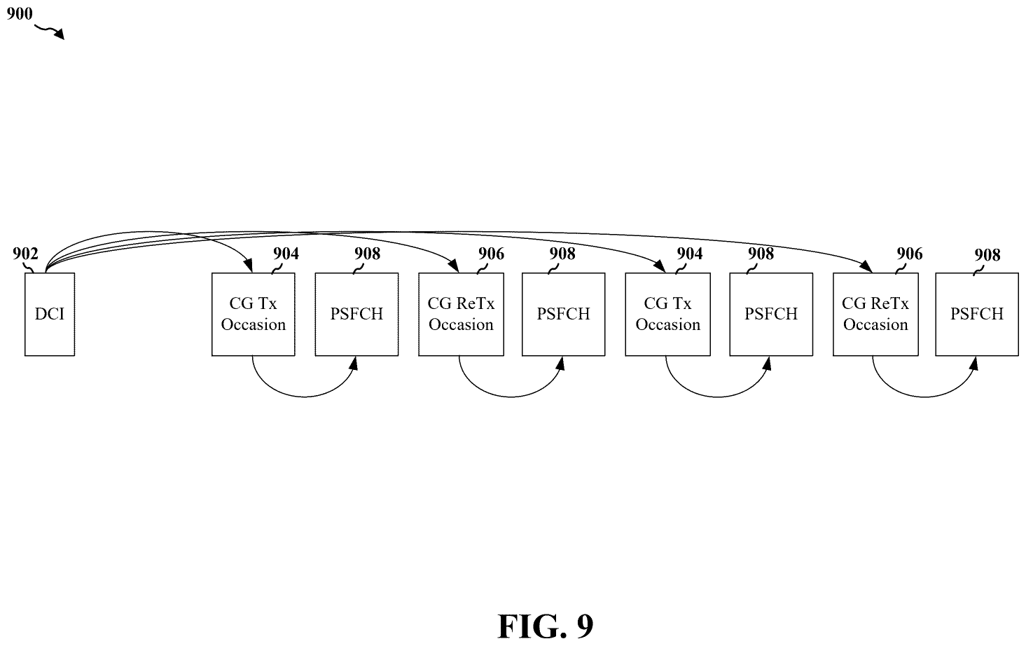

FIG. 9 illustrates an example 900 of a CG Type 2 which is activated by a DCI 902, where the DCI 902 activates a plurality of Tx occasions 904 or resources for initial sidelink data transmissions and schedules a plurality of ReTx occasions 906 or resources for respective sidelink data retransmissions. A PSFCH 908 with a given periodicity may be respectively associated with the PSSCH in each Tx occasion or ReTx occasion, such as previously described with respect to FIG. 8. While the illustrated example of FIG. 9 indicates one ReTx occasion associated with each Tx occasion, in other examples, a different quantity of ReTx occasions may be associated with each Tx occasion (e.g., two ReTx occasions).

Referring to FIGS. 5-9, a Tx UE may initially transmit sidelink data to an Rx UE in a reserved or configured resource. For example, if first UE 502 has data intended for second UE 504, the first UE may transmit SCI in PSCCH 706, and sidelink data in PSSCH 704, 802 of slot i in resource pool 600 or Tx occasion 904. The Tx UE may subsequently receive HARQ feedback (ACK or NACK) from the Rx UE in the PSFCH associated with the reserved or configured resource. For example, the first UE 502 may receive HARQ feedback 808 of the sidelink data from second UE 504 in PSFCH 708, 808, 908 of slot i. If the HARQ feedback is a NACK, the Tx UE may retransmit the sidelink data in the subsequent ReTx occasion; otherwise, if the HARQ feedback is an ACK, the Tx UE may subsequently transmit new sidelink data in the subsequent Tx occasion. For example, in response to receiving NACK from second UE 504 in PSFCH 708, 808, 908 of slot i, the first UE 502 may retransmit the sidelink data in PSSCH 704, 802 of slot i+x in resource pool 600 (scheduled by the prior SCI) or ReTx occasion 906. If multiple ReTx occasions are configured per Tx occasion (up to a maximum configured quantity of occasions), the Tx UE may retransmit the sidelink data in multiple ReTx occasions in response to receiving NACKs in associated PSFCHs. For example, following retransmission of the sidelink data in slot i+x, if the first UE 502 again receives a NACK from second UE 504 in PSFCH 708, 808, 908 of slot i+x, the UE 502 may again retransmit the sidelink data in PSSCH 704, 802 of slot i+y in resource pool 600 (again scheduled by the prior SCI) or another ReTx occasion. Otherwise, the Tx UE may not utilize the ReTx occasion (or cease utilizing ReTx occasions) if the Tx UE receives an ACK in a prior PSFCH.

While the typically configured periodicity between transmissions and retransmissions (or between successive retransmissions) in sidelink communication may be acceptable for typical UEs (e.g., the timing between slot i and slot i+x, or the timing between slot i+x and slot i+y), this periodicity may be insufficient if the Tx UE or the Rx UE is an EH device (e.g., third UE 506). This insufficiency is due to the EH device likely requiring additional time for battery charging or otherwise for harvesting sufficient ambient or dedicated (e.g., RF or wireless charging) energy for sidelink communication than other UEs. For example, third UE 506 may require additional time than the time configured between slot i and slot i+x (e.g., between Tx occasion 904 and ReTx occasion 906), or between slot i+x and slot i+y, to charge its battery or otherwise acquire sufficient energy to successfully receive a sidelink data retransmission from first UE 502 or to successfully retransmit sidelink data to second UE 504. Similarly, if an Rx UE or a Tx UE which relies on harvested energy 508 for sidelink communication does not have sufficient energy charged up at slot i+x or slot i+y in resource pool 600 (or ReTx occasions 906), that UE may not be able to successfully decode or encode the sidelink data retransmission. Therefore, it would be helpful for the typically configured periodicity between transmissions and retransmissions to be frozen or otherwise increased or lengthened to accommodate EH devices.

To this end, aspects of the present disclosure allow a base station or a UE in sidelink communication (e.g., an Rx UE or a Tx UE) to increase or lengthen a period between reserved or configured resources for sidelink data transmissions and retransmissions by a time offset or a quantity of slots z. For instance, to allow for additional time for energy harvesting, the time between slot i and slot i+x and/or the time between slot i+x and slot i+y in resource pool 600 may be increased by z slots, resulting in retransmissions occurring instead at slot i+x+z and/or slot i+y+z. Similarly, the periods between Tx occasions 904 and ReTx occasions 906 may be respectively increased by z time slots in the event of a CG. This time offset z may be applied to reserved or configured resources for sidelink data which a base station may schedule or activate in mode 1 resource allocation, in a dynamic grant, or in a CG, or which a UE may obtain in a mode 2 resource allocation. Thus, the likelihood of successful reception or transmission of sidelink data involving EH devices may be increased.

Aspects of the present disclosure relate to configuration or indication of time offsets z for EH devices. In one example, this time offset or increased period (z slots) may be configured per EH class (e.g., EH class 510) of the UE. For example, an EH class or classification may indicate a certain default charging rate, and thus a default time offset z, that an associated EH device may obtain. The EH device may increase or decrease its charging rate, and thus its applied time offset z, from this default rate over time. In another example, the resource pool (e.g., resource pool 600) in which the sidelink data is transmitted and retransmitted may be configured per EH class (e.g., EH class 510). A resource pool may be statically configured for an EH class (e.g., based on an EH class definition) or dynamically configured (e.g., based on current charging and discharging rates of the EH device). In either example, the time offset z applied to reserved or configured resources in a resource pool (whether or not associated with an EH class) may be configured or indicated in SCI, in a RRC configuration, in a MAC-CE configuration, in a DCI, or in some other manner using Uu interface L1/L2/L3 signaling or using PC5 interface L1/L2/L3 signaling or a combination thereof.

In one example, the base station may configure resource pools for sidelink communication and associate different EH classes or resource pools respectively with different time offsets z. Moreover, a Tx UE may indicate in SCI, an EH class of an Rx UE to which the Tx UE is sending data or serving. The Tx UE may be informed of the EH class of the Rx UE at the time of RRC connection, since UEs generally communicate with each other via RRC messaging to set up a sidelink connection at which time these UEs may respectively determine the EH class and other capabilities of the other UE. Alternatively, rather than indicating an EH class of an Rx UE in SCI, the Tx UE may directly indicate the time offset z in the SCI. In either case, other UEs configured with the same resource pool may sense the resources and determine from the SCI that an expected transmission from Tx UE may occur at either slot i+x, slot i+x+z, slot i+y, or slot i+y+z, where x and y are indicated in SCI, and z may be derived from the configured resource pool, or from the EH class or time offset indicated in SCI. These slots are potential ReTx occasions, since if the Rx UE is not an EH device, the retransmission(s) may occur at slot i+x and/or slot i+y, while if the Rx UE is an EH device and requests additional time for collecting or harvesting energy (e.g., as feedback in PSFCH), then time offset z may be applied. While this example illustrates one time offset z being applied to different ReTx occasions, in other examples, different time offsets z may be applied respectively to different ReTx occasions (e.g., one value zₓ for slot i+x+z, and another value z_{y} for slot i+y+z). Moreover, the time offset z may be statically associated with an EH class or resource pool, or the time offset z may be dynamically indicated in SCI (e.g., the time offset z may change over time). Additionally, multiple time offsets z may be applied respectively to different EH classes or resource pools, and at least one of these time offsets may be applied for an ReTx occasion.

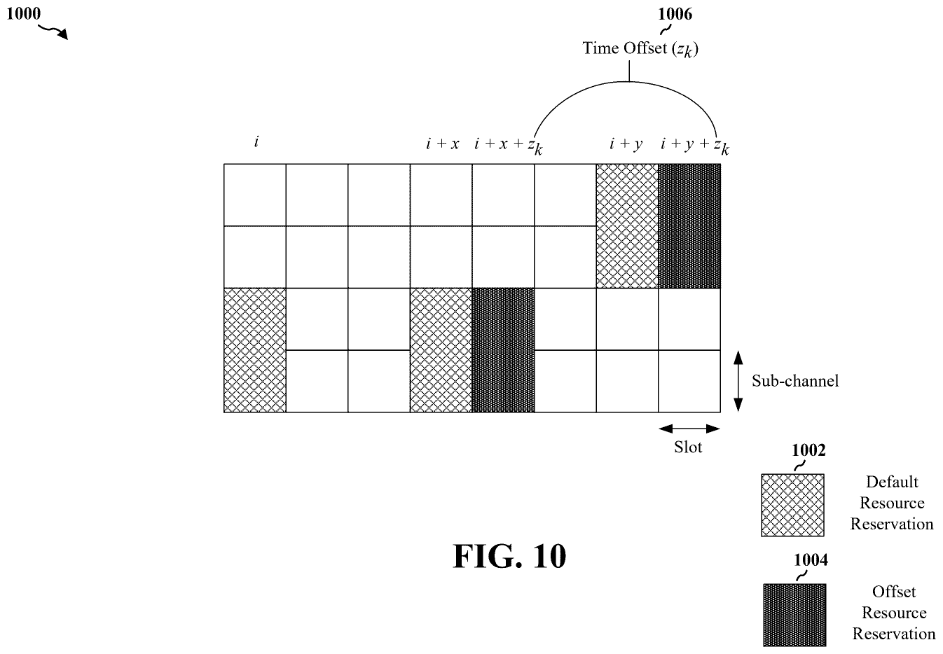

FIG. 10 illustrates an example of a resource pool 1000 for sidelink data communications configured with default resource reservations 1002 equivalent to those in resource pool 600 of FIG. 6, but further accommodating EH devices with offset resource reservations 1004 configured at a time offset 1006 with respect to the default resource reservations 1002. In one example, Rx UEs or Tx UEs which are EH devices may require additional time than provided by slot i+x and/or slot i+y to harvest enough energy for receiving re-transmitted sidelink data after receiving data at slot i, or for re-transmitting sidelink data after transmitting data at slot i, respectively. For instance, an Rx UE which is an EH device may have insufficient energy to decode a ReTx at slot i+x and/or slot i+y. As a result, the Rx UE may indicate to the Tx UE a request that the Tx UE freeze or otherwise increase the period between slot i and slot i+x and/or between slot i+x and slot i+y to delay the sidelink data retransmission until enough energy has been harvested at the Rx UE. The Tx UE may accomplish this freezing or lengthening by waiting an additional z slots in time before sending the ReTx. The Rx UE may indicate this request for the additional z time slots in PSFCH in response to the initial sidelink data transmission at slot i, for example, in a same RB or different RB than that including HARQ feedback.

EH devices may be grouped into EH classes defined by or associated with a charging rate (e.g., a minimum rate or a default rate), a maximum energy storage unit size (e.g., how much energy its battery or energy storage unit (e.g., supercapacitor, etc.) can store), and a minimum time offset or gap between two transmissions, receptions, or a combination of both. The base station may configure (or pre-configure) one or more time offsets z for respective EH classes k. These time offset(s) z, per EH class k, may be represented by time offsets zₖ. A time offset zₖ may be based on a minimum time gap defined between transmissions and/or receptions for a respective EH class. Thus, EH classes may indicate how much time an Rx UE or Tx UE may spend to harvest sufficient energy to respectively obtain or provide re-transmitted sidelink data. The base station may indicate the value(s) of zₖ for respective EH classes k while configuring a sidelink resource pool (e.g., resource pool 1000) for a Tx UE and an Rx UE (or during RRC connection of such UEs to the base station). In some cases, the Tx UE and the Rx UE can agree on one of the values during RRC connection or using L1/L2/L3 indication (e.g., via layer 1, layer 2, or layer 3 signaling). During transmission from Tx UE to Rx UE (assuming Rx-UE is the EH device), the Tx-UE may indicate the time offsets, or indicate the Rx-UE class, or indicate Rx-UE class and the time offsets. In some cases, in the PSFCH feedback corresponding to a transmission, the Rx-UE can indicate if it needs more time for ReTx from a set of configured time offsets or can indicate a new time offset (e.g., based on its current charging rate, battery status, or discharging rate).

In one example, when transmitting data to an Rx UE which is an EH device, the Tx UE may be configured to apply one or more of the time offsets zₖ associated with an EH class k of the Rx UE, in order to meet a minimum timing between transmissions defined for an EH class of that Rx UE. Since these time offsets would affect the potential timing of a sidelink data retransmission, it would be helpful for other UEs than the Tx UE or Rx UE to ascertain this information to avoid collisions or conflicts with their own sidelink data communications. While UEs may individually obtain such EH classes or time offsets during an RRC connection with the base station, this approach may result in significant overhead since the base station would end up announcing this information to numerous UEs. Therefore, as these UEs can sense and reserve resources for their own sidelink communications (e.g., in a mode 2 resource allocation), the Tx UE may instead inform these UEs (as well as the Rx UE) of the EH class or time offset associated with an Rx UE or sidelink retransmission in SCI. For example, the Tx UE may indicate the EH class or time offset in SCI-1, which may be decoded by the other UEs as well as the Rx UE. Alternatively, the Tx UE may indicate this information in SCI-2, which information may be multiplexed with the PSSCH and decoded by the Rx UE.

In one approach, the Tx UE may indicate the EH class k of the EH device in SCI, and other UEs decoding the signal may determine the associated value of zₖ from the EH class. In another approach, the Tx UE may indicate the value of zₖ directly in the SCI, rather than the EH class. As a result, in either case, UEs may ascertain the potential slots i+x, i+x+zₖ, i+y, or i+y+zₖ in which the sidelink ReTx may potentially occur. The Tx UE may subsequently provide the ReTx in one of these slots depending on whether the Tx UE receives an indication from the RxUE in PSFCH requesting application of the time offset zₖ (referred to as an EH indication). For example, if the Tx UE does not receive an EH indication from the Rx UE in the PSFCH of slot i, the Tx UE may send the ReTx in slot i+x, while if the Tx UE does receive an EH indication from the Rx UE in the PSFCH of slot i, the Tx UE may send the ReTx in slot i+x+zₖ. Similarly, if the Tx UE does not receive an EH indication from the Rx UE in the PSFCH of slot i+x, the Tx UE may send the ReTx in slot i+y, while if the Tx UE does receive an EH indication from the Rx UE in the PSFCH of slot i+x, the Tx UE may send the ReTx in slot i+y+zₖ.

The EH indication from the Rx UE, which informs the Tx UE whether to send the ReTx without applying a time offset zₖ (utilizing default resource reservations 1002) or with application of time offset zₖ (utilizing offset resource reservations 1004) may be provided in various manners. In one example, the Rx UE may multiplex the EH indication in a same RB as HARQ feedback by utilizing a joint cyclic shift. For instance, when generating a baseband sequence (or other sequence) for a PSSCH transmission which utilizes a cyclic shift, the Rx UE may apply a different cyclic shift respectively for different bit combinations of HARQ-ACK and EH indications, where HARQ-ACK=0 indicates a NACK while HARQ-ACK=1 indicates an ACK (or vice-versa), and where EH indication=0 activates or indicates default resource reservations 1002 while EH indication=1 activates or indicates offset resource reservations 1004 (or vice-versa). As an example, the Rx UE may apply a cyclic shift of 0 for HARQ-ACK=0 and EH indication=0; a cyclic shift of 3 for HARQ-ACK=0 and EH indication=1; a cyclic shift of 6 for HARQ-ACK=1 and EH indication=1; and a cyclic shift of 9 for HARQ-ACK=1 and EH indication=0. In another example, the Rx UE may transmit the EH indication in a different RB than the HARQ feedback, as opposed to the same RB as in the previous example. In a further example, the Rx UE may not expressly transmit an EH indication per se, but may impliedly provide the EH indication by shifting the RB which the Rx utilizes for HARQ-ACK. For instance, referring to the example of FIG. 8 where PSSCH 802 is mapped to resource 804 (e.g., PRBs) in PSFCH 806, the Rx UE may transmit HARQ feedback 808 in one of these associated PRBs when requesting utilization of default resource reservations 1002 and in a different one of these associated PRBs when requesting utilization of offset resource reservations 1004. In such example, the Tx UE may blindly decode the PSFCH for the HARQ feedback and determine whether or not to apply the time offset zₖ depending on the RB in which successfully decoded HARQ feedback was obtained.

In another example, the EH indication from the Rx UE may adjust a previously configured value of the time offset zₖ. This adjustment may be performed dynamically according to the situation of the Rx UE (e.g., if the Rx UE requires more time for energy harvesting and thus a larger time offset, the Rx UE may request the Tx UE to increase zₖ for its next ReTx, while if the Rx UE requires less time for energy harvesting and thus a smaller time offset, the Rx UE may request the Tx UE to decrease zₖ for its next ReTx). Thus, rather than sending one or more bits in PSFCH to the Tx UE indicating whether or not to apply offset resource reservation 1004 (a single time offset zₖ), the Rx UE may select one of a set of multiple configured time offsets zₖ and provide one or more bits in PSFCH indicating the selected value to be applied. The Rx UE may provide the EH indication including the selected time offset to the Tx UE according to any of the foregoing examples described previously (e.g., expressly in a same RB as HARQ-ACK utilizing a joint cyclic shift or in a different RB than HARQ-ACK, or impliedly via the HARQ-ACK based on the RB in which the HARQ-ACK is transmitted). For example, in a set of four time offsets, the Rx UE may apply one of four cyclic shifts to indicate one of four configured values of zₖ for a two-bit EH indication, or the Rx UE may transmit the EH indication or HARQ feedback in one of four RBs respectively associated with a different value of zₖ.

In one example, the set of multiple time offsets zₖ may be associated with an EH class k for a configured resource pool utilized by the Rx UE and Tx UE, and the Rx UE may select the time offset to be applied from this configured set. In other examples, the Rx UE may select the applied time offset from a list of multiple time offsets upon which the Tx UE and Rx UE previously agreed during an RRC connection, from an RRC-configured, MAC-CE configured, or SCI or DCI configured list of multiple time offsets (which list a base station or UE may update over time), or from a codebook including multiple defined time offsets between the Tx UE and Rx UE.

Thus, in the foregoing examples, the Tx UE may provide an initial sidelink data transmission in slot i, the Tx UE may receive an EH indication from the Rx UE in the PSFCH of slot i requesting additional time for energy harvesting, and in response to the EH indication, the Tx UE may apply a time offset zₖ for the EH class k of the Rx UE. However, in other examples, application of time offset zₖ for the EH class k of the Rx UE may further depend on the value of time offset zₖ. For instance, while in one example the Tx UE may send a ReTx in slot i+x+zₖ as previously described, in another example, the Tx UE may send the ReTx instead at slot i+y notwithstanding the EH indication, based on the value of time offset zₖ.

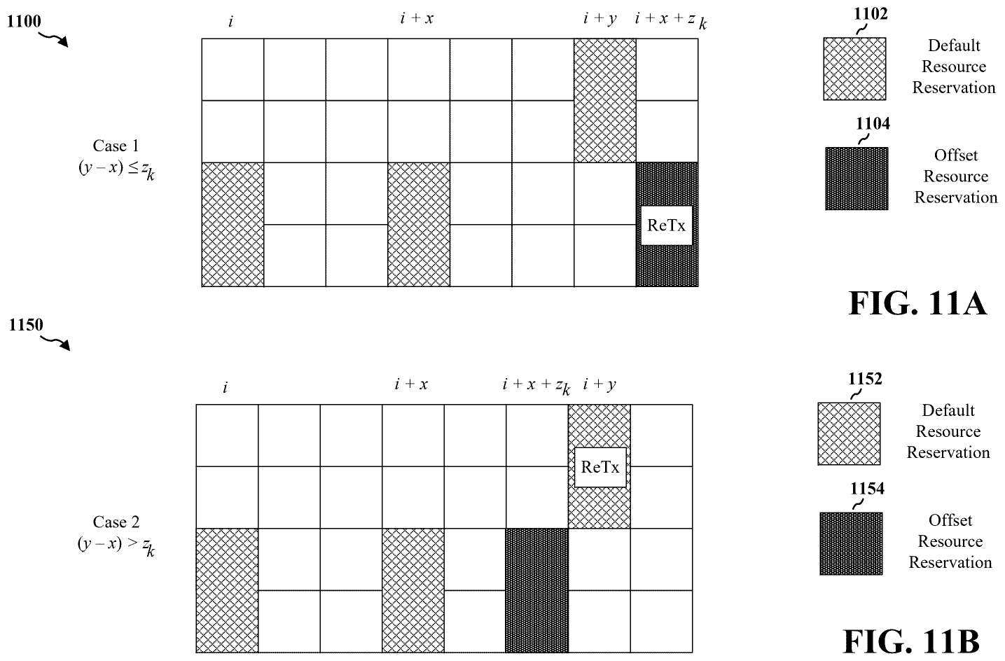

FIGS. 11A and 11B illustrate examples of resource pools 1100, 1150 including default resource reservations 1102, 1152 and offset resource reservations 1104, 1154 (similar to the default resource reservations 1002 and offset resource reservations 1004 of resource pool 1000 in FIG. 10), but where the offset resource reservations 1104, 1154 are at different time offsets zₖ which affect the timing of a scheduled ReTx. In particular, FIG. 11A illustrates the case where a difference in time between slot i+y and slot i+x is less than or equal to zₖ (i.e., (y−x)≤zₖ, or slot i+x+zₖ is the same as or later in time than slot i+y), while FIG. 11B illustrates the case where a difference in time between slot i+y and slot i+x is greater than zₖ (i.e., (y−x)>zₖ, or slot i+x+zₖ is earlier in time than slot i+y). In the example of FIG. 11A, the Tx UE may send the sidelink data retransmission in slot i+x+zₖ, and refrain from or skip sending the ReTx in slot i+y, since applying the time offset zₖ in this case would allow the Rx UE to harvest more energy for receiving the ReTx than the alternative. On the other hand, in the example of FIG. 11B, the Tx UE may send the sidelink data retransmission in slot i+y, and refrain from or skip sending the ReTx in slot i+x+zₖ (notwithstanding the EH indication), since not applying the time offset zₖ in this case would allow the Rx UE to harvest more energy for receiving the ReTx than the alternative.

Thus, the Tx UE may determine whether or not to apply time offset zₖ not only based on the EH indication which the Rx UE provides requesting application of the time offset as previously described, but also based on the value of this time offset. For instance, in the examples of FIGS. 11A and 11B, the Tx UE may dynamically determine whether or not to apply the time offset zₖ based on its value. Thus, if the Rx UE adjusts the value of zₖ in its EH indication as described in one of the foregoing examples, the Tx UE may adjust the timing of its ReTx based on the adjusted value of zₖ (e.g., by applying time offset zₖ such as illustrated in FIG. 11A or by not applying time offset zₖ such as illustrated in FIG. 11B). Moreover, in either example, if the Tx UE receives an EH indication from the Rx UE requesting to apply the time offset and the Tx UE intends to schedule multiple ReTx's (e.g., by default in slot i+x and slot i+y), the time offset may still be applied to slot i+y notwithstanding whether it is applied to slot i+x. For instance, even if the Tx UE determines not to apply the time offset zₖ due to its value for slot i+x and instead send the ReTx in slot i+y such as illustrated in FIG. 11B, the Tx UE may still nevertheless apply the time offset zₖ for slot i+y and send a second ReTx in slot i+y+zₖ accordingly. Moreover, other UEs than the Tx UE and Rx UE may determine the timing of the multiple ReTx's based on the SCI, PSFCH feedback, and value of the time offset.

In the foregoing examples, the Rx UE may transmit an EH indication in the PSFCH of slot i requesting, or not requesting, additional time for energy harvesting to receive a sidelink data retransmission, in response to which the Tx UE may provide the ReTx at slot i+x+zₖ (if requesting), or slot i+x (if not requesting), respectively. Similarly, the Rx UE may transmit an EH indication in the PSFCH of slot i+x requesting, or not requesting, additional time for energy harvesting to receive a sidelink data retransmission, in response to which the Tx UE may provide the ReTx at slot i+y+zₖ (if requesting), or slot i+y (if not requesting), respectively. Moreover, in other examples, the Rx UE may additionally or alternatively transmit an EH indication in the PSFCH associated with an offset resource reservation, rather than a default resource reservation for a sidelink data retransmission as in the foregoing examples. For example, the Rx UE may transmit an EH indication in the PSFCH of slot i+x+zₖ requesting, or not requesting, additional time for energy harvesting to receive another sidelink data retransmission, in response to which the Tx UE may provide the ReTx at slot i+y+zₖ (if requesting), or slot i+y (if not requesting). Similarly, the Rx UE may transmit an EH indication in the PSFCH of slot i+y+zₖ requesting additional time for energy harvesting to receive another sidelink data retransmission, in response to which the Tx UE may apply the time offset zₖ to a subsequent slot for the ReTx (after slot i+y+zₖ). Thus, the Rx UE may provide the EH indication in a PSFCH associated with any potential time slot for a sidelink data retransmission, so long as such EH indication would not result in the ReTx being provided outside a maximum quantity of available slots for transmission and retransmission of a same TB (e.g., 32 slots or some other quantity) or a maximum quantity of configured resource reservations for transmission and retransmission of a same TB (e.g., three resource reservations or some other quantity)

As previously described, the Tx UE may indicate the time offset zₖ for an EH class k in SCI in any of the foregoing examples. For instance, the Tx UE may include the EH class k in SCI directly, in response to which inclusion the Rx UE and other UEs may derive the associated time offset zₖ, or the Tx UE may include the time offset zₖ in SCI directly. Alternatively, in any of the foregoing examples, the base station may configure a dedicated resource pool for a respective EH class k (including different resource pools respectively for different EH classes), and the base station may configure the time offset zₖ for the respective resource pool (and thus different time offsets respectively for different EH classes k). In such case, the Tx UE may not indicate the EH class or time offset in SCI (e.g., there is no change in conventional SCI); instead, the Rx UE and other UEs which are configured to perform sidelink communications in the dedicated resource pool may ascertain or derive the associated EH class k and time offset zₖ from that resource pool configuration. Regardless of whether the SCI or the resource pool indicates the EH class or time offset, the Rx UE may provide EH indications to the Tx UE whether or not to apply the configured time offset for its ReTx's as previously described. However, in the case where the resource pool indicates the EH class or time offset, the Rx UE may request application of a different time offset zₖ for subsequent ReTx's of Tx UE, for example, by requesting the base station to provide a different resource pool configuration associated with a different time offset, or to indicate a different time offset in some other manner.

Notwithstanding whether an SCI and/or a resource pool indicates an EH class or time offset to be applied to sidelink data retransmissions, the base station may configure (or there may be pre-configured) a set of multiple time offsets zₖ for a respective EH class k. In such case, the Tx UE may dynamically change a currently applied time offset zₖ, for an EH class of the Rx UE to a different time offset in the set of multiple time offsets zₖ associated with that EH class or resource pool. For example, the Tx UE may change the time offset to be applied to a sidelink data retransmission in response to feedback from the Rx UE following a prior sidelink data transmission (or earlier retransmission), or prior to a subsequent new sidelink data transmission. For instance, the Rx UE may indicate that its current charging and/or discharging rate for energy harvesting has changed or the Tx UE may collect some other feedback from the Rx UE prompting selection of a different time offset for that Rx UE. The Tx UE may then indicate the changed time offset in SCI so that the Rx UE and other UEs may ascertain the new potential slot(s) for subsequent ReTx's. The Tx UE may also determine whether or not to apply this new time offset depending if the Rx UE requests application of the changed time offset (e.g., in an EH indication). For example, following an initial Tx, the Tx UE may apply one time offset for subsequent ReTx(s), the Rx UE may feedback that its charging rate has changed, the Tx UE may select a different time offset in response to the feedback, the Tx UE may provide another initial Tx, and then the Tx UE may apply the changed time slot for subsequent ReTx('s) based on an EH indication from the Rx UE.

Although the foregoing examples describe the Rx UE as being an EH device, these examples may similarly apply in the alternative where the Tx UE is the EH device. For instance, the Tx UE may be an EH device that requires additional time to harvest energy before sending a sidelink data retransmission at slot i+x or slot i+y. In such case, the Tx UE may itself select the time offset zₖ it intends to apply (e.g., a time offset associated with an EH class k of the Tx UE) based on its charging and/or discharging rates, EH capability, or other factors such as those previously described with respect to the Rx UE (e.g., an associated resource pool, set of multiple time offsets, etc.). The Tx UE may also select the time offset based on various transmission factors, such as a time required for preparing the sidelink data retransmission, a time required for encoding, and the like. After selecting or determining the time offset zₖ, the Tx UE may indicate this time offset to the Rx UE (and other UEs) in SCI by including the associated EH class or the time offset directly, such as previously described. Thus, other UEs than the Rx UE may similarly determine from the SCI the potential times which the Tx UE may utilize for its sidelink data retransmissions (e.g., slot i+x, slot i+x+zₖ, slot i+y, or slot i+y+zₖ), and these other UEs may similarly refrain from reserving these potential resources when sensing available resources for their own sidelink data transmissions.

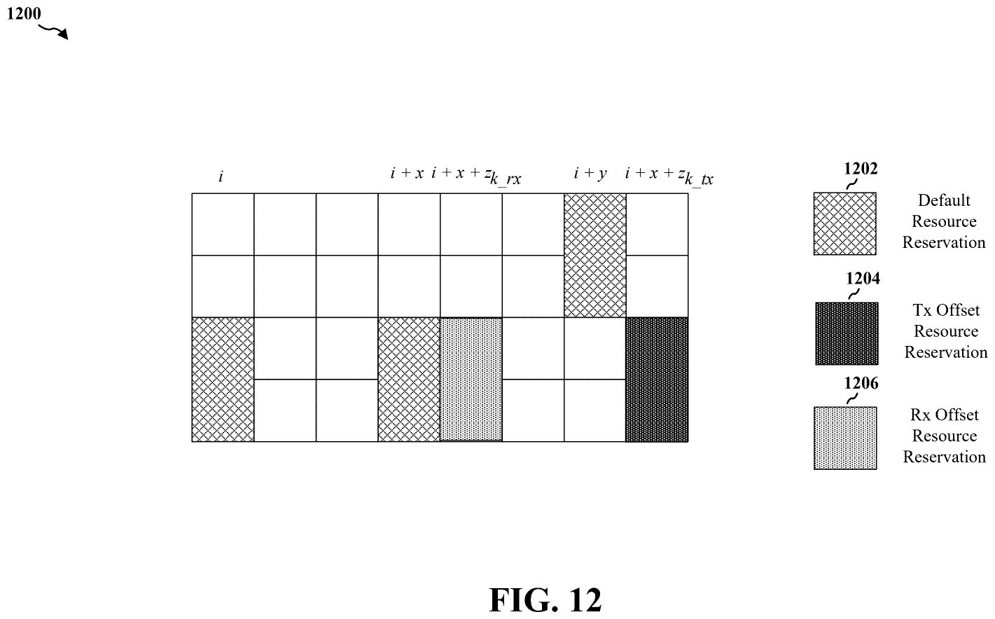

FIG. 12 illustrates an example of a resource pool 1200 including default resource reservations 1202 and offset resource reservations 1204, 1206 (similar to the default resource reservations 1002, 1102, 1152 and offset resource reservations 1004, 1104, 1154 of resource pool 1000, 1100, 1150 in FIGS. 10 and 11A-11B, respectively), but where the offset resource reservations are at different time offsets zₖ associated respectively with transmission and reception. For instance, for EH devices of a certain class k, the time required to harvest sufficient energy between two transmissions (for providing a sidelink data retransmission) may be different than the time required to harvest sufficient energy between two receptions (for obtaining a sidelink data retransmission). This difference in time exists because the energy that an EH device may consume for a single transmission (e.g., a data encoding energy cost or other transmission energy cost) is different than the energy than the EH device may consume for a single reception (e.g., a data decoding energy cost or other reception energy cost). Therefore, different time offsets zₖ may be respectively configured for transmission and reception in a same EH class, including a time offset z_{k_tx} for transmissions and a time offset z_{k_rx} for receptions, to accommodate the different timings an EH device may require for harvesting additional energy for sidelink data retransmissions. Thus, as illustrated in the example of FIG. 12, offset resource reservations 1204, 1206 may respectively include transmission offset resource reservations at slot i+x+z_{k_tx} (and slot i+y+z_{k_tx}) and reception offset resource reservations at slot i+x+z_{k_rx} (and slot i+y+z_{k_rx}).

Thus, in the foregoing examples, the base station may configure different time offsets zₖ associated respectively with transmission and reception, and any reference to time offset zₖ in the foregoing examples may accordingly refer to time offset z_{k_rx} for receptions by Rx UE or time offset z_{k_tx} for transmissions by Tx UE. Accordingly, for a particular EH class k, a Tx UE which is an EH device may rely on configured, pre-configured, or dynamically selected time offsets z_{k_tx} for transmissions, while a Rx UE which is an EH device may rely on configured, pre-configured, or dynamically selected time offsets z_{k_rx} for receptions. In such case where different time offsets are configured for reception and transmission, time offset z_{k_tx} is typically larger than time offset z_{k_rx} (such as illustrated in the example of FIG. 12), since transmitting data generally requires more power (and thus more EH time) than receiving data.

Alternatively, the base station may configure a single time offset zₖ associated with both transmission and reception, which offset may be applied as described in the foregoing examples. In such case where a single time offset is configured for reception and transmission, the base station may select the value of zₖ to be the maximum quantity of slots (or other value) that the EH device would require to harvest sufficient energy for transmission or reception. Typically, the maximum quantity would be associated with transmission, since as previously described, transmitting data generally requires more power (and thus more EH time) than receiving data. Thus, in an alternative example to the example of FIG. 12, the base station may instead configure a single time offset zₖ in place of time offset z_{k_tx}, since the maximum between z_{k_tx} (transmission) and z_{k_rx} (reception) is z_{k_tx} (transmission). In other words, in this alternative example, offset resource reservations 1204, 1206 for transmission and reception of sidelink data retransmissions, respectively, may both be located at slot i+x+z_{k_tx} (and slot i+y+z_{k_tx}).

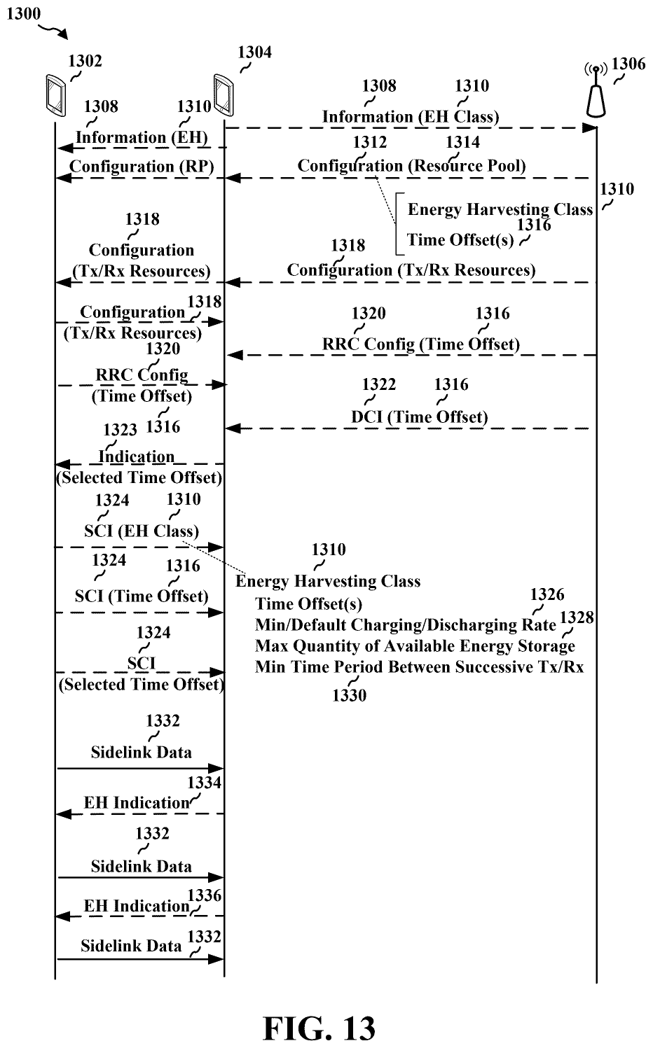

FIG. 13 is an example 1300 of a call flow between a Tx UE 1302, a Rx UE 1304, and a base station 1306. In the illustrated example, the Rx UE 1304 is an EH device (e.g., third UE 506 in FIG. 5), and the Tx UE does not harvest energy for its sidelink transmissions (e.g., first UE 502 in FIG. 5). However, it should be understood that in other examples, the Tx UE 1302 may be the EH device (e.g., third UE 506 in FIG. 5), while the Rx UE does not harvest energy for its sidelink receptions (e.g., second UE 504 in FIG. 5). Alternatively, the Tx UE 1302 and the Rx UE 1304 may both be EH devices. In either case, similar points as those to be described may be applied for those UEs which are EH devices.

Initially, the Rx UE 1304 transmits information 1308 to the base station 1306 and/or to the Tx UE 1302. The transmission of information 1308 may occur, for example, during an RRC connection of the Rx UE 1304 with the base station 1306 and/or Tx UE 1302. The information may include, for example, capability information of the Rx UE, including an EH class 1310 of the Rx UE 1304. Similarly, if the Tx UE is an EH device, the Tx UE may transmit information 1308 including its EH class to the Rx UE and/or base station.

The Rx UE 1304 (or Tx UE 1302) may receive one or more configurations from the base station 1306 or the Tx UE 1302 (or Rx UE 1304). The configuration(s) may be, for example, a CG configuration for a type-1 SL configured grant, DCI for a type-2 SL configured grant, DCI for mode 1 resource allocation, a sidelink resource pool configuration (e.g., applied for mode 2 resource allocation), or SCI. In one example, the base station 1306 may transmit a configuration 1312 to the Rx UE 1304 and Tx UE 1302 indicating a resource pool 1314 including resources (e.g., slots, sub-channels, RBs) which the Tx UE 1302 and Rx UE 1304 may apply for sidelink communication. The resource pool 1314 may be associated with the EH class 1310 of the Rx UE 1304 (and/or Tx UE 1302). The resource pool 1314 may additionally or alternatively be associated with one or more time offsets 1316 (a single time offset zₖ or set of multiple time offsets zₖ, time offsets z_{k_rx}, z_{k_tx}, etc.) In another example, the base station 1306 may transmit a configuration 1318 to the Rx UE 1304 and Tx UE 1302 indicating, scheduling, or activating resources (e.g., slots, sub-channels, RBs) for sidelink communication, such as resources within resource pool 1314 (e.g., in a mode 1 sidelink resource allocation). In another example, the Tx UE 1302 may transmit configuration 1318 to the Rx UE 1304 (e.g., in a mode 2 sidelink resource allocation). The resources in configuration 1318 may include, at least, a Tx occasion and a ReTx occasion. For instance, the Tx occasion may be slot i in resource pool 600, 1000, 1100, 1150, 1200 or Tx occasion 904, and the ReTx occasion may be slot i+x in resource pool 600, 1000, 1100, 1150, 1200 or ReTx occasion 906.

In a further example, the Rx UE 1304 may receive an RRC configuration 1320 from the base station 1306 or the Tx UE 1302 indicating the time offset(s) 1316. For instance, the Rx UE 1304 may receive the RRC configuration 1320 during an RRC connection of the Rx UE with the base station and/or Tx UE where the Rx UE (or Tx UE) shares its capability information (e.g., in information 1308). In another example, the Rx UE 1304 may receive a DCI 1322 from the base station 1306 indicating the time offset(s) 1316. For instance, the Rx UE 1304 (or Tx UE 1302) may receive DCI 1322 including a dynamically changed time offset in response to indicating (e.g., in information 1308) new charging and discharging rates. In another example, the Rx UE 1304 may receive a MAC-CE indicating the time offset(s) 1316.

In one example, the Rx UE 1304 may select a value for the time offset(s) 1316, for example, from a set of multiple configured time offsets zₖ per EH class k per resource pool, from an agreed list of potential values between Tx UE 1302 and Rx UE 1304 (e.g., during an RRC connection), from values updated over time using a layer 1, layer 2, or layer 3 indication, or from values in a codebook defined between the UEs. The Rx UE 1304 may then transmit an indication 1323 of this selected time offset to the Tx UE 1302 to apply in its subsequent sidelink data transmissions and retransmissions.

In another example, the Tx UE 1302 may transmit SCI 1324 to the Rx UE 1304. In addition to indicating the resources to be applied for transmission of sidelink data, the SCI 1324 may indicate the EH class 1310 of the Rx UE 1304. Alternatively, the SCI 1324 may indicate the time offset(s) 1316 directly. Alternatively, the Tx UE 1302 may select a value for the time offset(s) 1316, for example, from a set of multiple configured time offsets zₖ per EH class k per resource pool, from an agreed list of potential values between Tx UE 1302 and Rx UE 1304 (e.g., during an RRC connection), from values updated over time using a layer 1, layer 2, or layer 3 indication, or from values in a codebook defined between the UEs. In such case, the Tx UE 1302 may indicate the selected time offset in SCI 1324 according to either of the foregoing examples (e.g., via the EH class 1310 or the time offset directly). The EH class 1310 of the Rx UE 1304 may be associated with the time offset(s) 1316, a minimum or default charging rate 1326 of the Rx UE, a maximum quantity of available energy storage 1328 at the Rx UE, and/or a minimum time period 1330 between successive transmissions or receptions at the Rx UE. Similarly, if the Tx UE 1302 is an EH device, its EH class may be associated with the time offset(s) 1316, the minimum or default charging rate 1326 of the Tx UE, the maximum quantity of available energy storage 1328 at the Tx UE, and/or the minimum time period 1330 between successive transmissions or receptions at the Tx UE. In one example, the time offset(s) 1316 indicated in SCI 1324 may be selected time offset(s) which the Rx UE 1304 previously indicated to the Tx UE 1302 (e.g., in indication 1323).

In one example, the Tx UE 1302 may transmit sidelink data 1332 to the Rx UE 1304 in a configured or reserved Tx occasion (e.g., indicated in a configuration from the base station or autonomously determined). For instance, the Tx UE 1302 may transmit sidelink data 1332 to Rx UE 1304 in slot i in resource pool 600, 1000, 1100, 1150, 1200 or Tx occasion 904. If the Rx UE 1304 fails to successfully receive the sidelink data 1332, the Rx UE 1304 may transmit an EH indication 1334 in a PSFCH associated with the Tx occasion (e.g., in the PSFCH of slot i or Tx occasion 904) requesting or not requesting the Tx UE to apply the time offset(s) 1316 for a subsequent ReTx.

In response to receiving the EH indication 1334, if the Rx UE did not request application of time offset(s) 1316 in the EH indication, the Tx UE 1302 may retransmit sidelink data 1332 to Rx UE 1304 in the configured or reserved ReTx occasion (e.g., indicated in a configuration from the base station or autonomously determined). For instance, the Tx UE 1302 may retransmit sidelink data 1332 to Rx UE 1304 in slot i+x in resource pool 600, 1000, 1100, 1150, 1200 or ReTx occasion 906. Alternatively, if the EH indication 1334 requested application of time offset(s) 1316, then the Tx UE 1302 may retransmit sidelink data 1332 to Rx UE 1304 in a resource offset in time (at time offset 1316) with respect to the configured or reserved ReTx occasion. For instance, the Tx UE 1302 may retransmit sidelink data 1332 to Rx UE 1304 in slot i+x+zₖ in resource pool 600, 1000, 1100, 1150, 1200. If the Rx UE 1304 still fails to successfully receive the sidelink data 1332, the Rx UE 1304 may transmit an EH indication 1336 in a PSFCH associated with the ReTx occasion (e.g., in the PSFCH of slot i+x or ReTx occasion 906, or in the PSFCH of slot i+x+zₖ) requesting or not requesting the Tx UE to apply the time offset(s) 1316 for another ReTx.

In response to receiving the EH indication 1336, if the Rx UE did not request application of time offset(s) 1316 in the EH indication, the Tx UE 1302 may retransmit sidelink data 1332 to Rx UE 1304 in the next configured or reserved ReTx occasion (e.g., indicated in a configuration from the base station or autonomously determined). For instance, the Tx UE 1302 may retransmit sidelink data 1332 to Rx UE 1304 in slot i+y in resource pool 600, 1000, 1100, 1150, 1200 or another ReTx occasion 906. Alternatively, if the EH indication 1336 requested application of time offset(s) 1316, then the Tx UE 1302 may retransmit sidelink data 1332 to Rx UE 1304 in a resource offset in time (at time offset 1316) with respect to the next configured or reserved ReTx occasion. For instance, the Tx UE 1302 may retransmit sidelink data 1332 to Rx UE 1304 in slot i+y+zₖ in resource pool 600, 1000, 1100, 1150, 1200.

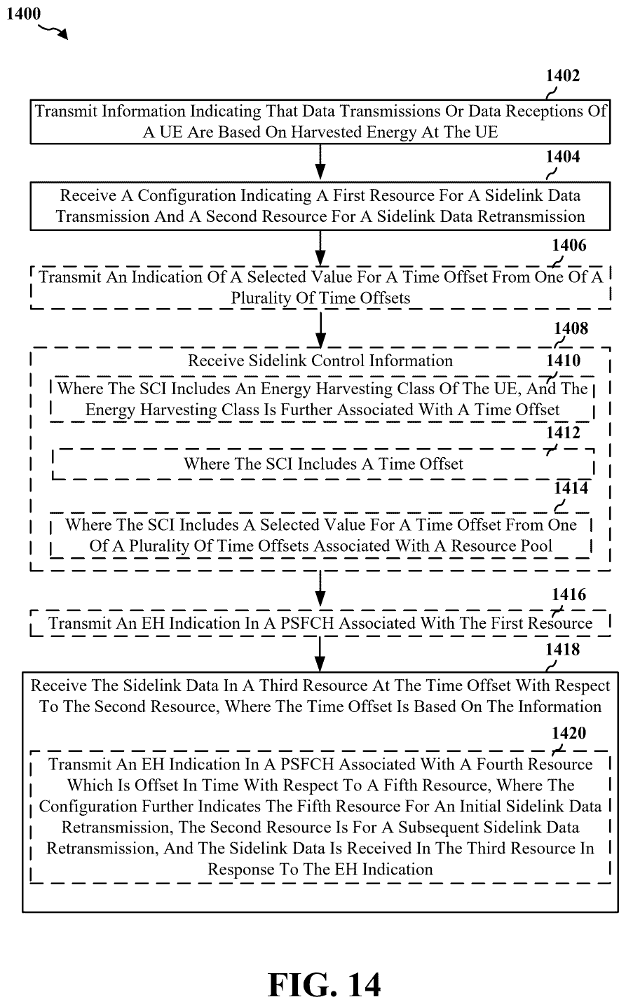

FIG. 14 is a flowchart 1400 of a method of wireless communication. The method may be performed by an Rx UE (e.g., the UE 104, 1304; the second wireless communication device 450; third UE 506; the apparatus 1602) which harvests energy for performing communications with other UEs. Optional aspects are illustrated in dashed lines. The method allows an Rx UE which is an EH device to obtain sidelink data retransmissions as a result of an increased or lengthened period between reserved or configured resources for sidelink data transmissions and retransmissions by a time offset.

At 1402, the Rx UE transmits information indicating that data transmissions or data receptions of the apparatus are based on harvested energy at the apparatus. For example, 1402 may be performed by information component 1640. For instance, referring to FIG. 13, the Rx UE 1304 may transmit information 1308 including EH class 1310 of the Rx UE 1304. The information 1308 (e.g., the EH class 1310) may indicate that data transmissions or data receptions of the Rx UE 1304 are based on harvested energy at the Rx UE (e.g., harvested energy 508 in FIG. 5).

At 1404, the Rx UE receives a configuration indicating a first resource for a sidelink data transmission and a second resource for a sidelink data retransmission. For example, 1404 may be performed by configuration component 1642. For instance, referring to FIG. 13, the Rx UE 1304 may receive configuration 1318 indicating, scheduling, or activating resources (e.g., slots, sub-channels, RBs) for sidelink communication, such as resources within resource pool 1314 (e.g., in a mode 1 sidelink resource allocation or a mode 2 sidelink resource allocation). The resources in configuration 1318 may include, at least, a Tx occasion (the first resource) and a ReTx occasion (the second resource). For instance, the Tx occasion may be slot i in resource pool 600, 1000, 1100, 1150, 1200 or Tx occasion 904, and the ReTx occasion may be slot i+x or slot i+y in resource pool 600, 1000, 1100, 1150, 1200 or ReTx occasion 906.

At 1406, the Rx UE may transmit an indication of a selected value for a time offset from one of a plurality of time offsets. For example, 1406 may be performed by time offset indication component 1650. For instance, referring to FIG. 13, Rx UE 1304 may transmit indication 1323 of time offset 1316 including a selected value for zₖ from a plurality of time offsets zₖ.

At 1408, the Rx UE may receive sidelink control information. For example, 1408 may be performed by SCI component 1644. For instance, referring to FIG. 13, the Rx UE 1304 may receive SCI 1324 from Tx UE 1302. In one example, at 1410, the SCI includes an energy harvesting class of the apparatus, and the energy harvesting class is further associated with the time offset. For instance, referring to FIG. 13, the SCI 1324 may include the EH class 1310 of the Rx UE 1304, and the EH class 1310 may be associated with the time offset 1316 (e.g., time offset zₖ for EH class k). In another example, at 1412, the SCI includes the time offset. For instance, referring to FIG. 13, the SCI 1324 may directly indicate the time offset 1316 (e.g., expressly, rather than via an EH class). In another example, at 1414, the SCI includes a selected value for the time offset from one of a plurality of time offsets associated with a resource pool. For instance, referring to FIG. 13, the Tx UE 1302 may select a value for the time offset(s) 1316, for example, from a set of multiple configured time offsets zₖ per EH class k per resource pool, from an agreed list of potential values between Tx UE 1302 and Rx UE 1304 (e.g., during an RRC connection), from values updated over time using a layer 1, layer 2, or layer 3 indication, or from values in a codebook defined between the UEs. In such case, the Tx UE 1302 may indicate the selected time offset in SCI 1324 according to either of the foregoing examples (e.g., via the EH class 1310 or the time offset 1316 directly).

In one example, the time offset is associated with an energy harvesting class of the apparatus. For instance, referring to FIG. 13, the time offset 1316 may be configured based on, mapped with, or otherwise associated with the EH class 1310 of the Rx UE 1304 (e.g., time offset zₖ for EH class k). In another example, an energy harvesting class of the apparatus is associated with a plurality of time offsets including the time offset. For instance, referring to FIG. 13, a plurality of time offsets may be configured based on, mapped with, or otherwise associated with the EH class 1310 of the Rx UE 1304 (e.g., multiple time offsets zₖ for EH class k), and the time offset 1316 which the Tx UE 1302 applies to its sidelink data retransmissions may be one of these time offsets. In various examples, an energy harvesting class of the apparatus indicates a minimum or default charging rate of the apparatus, a maximum quantity of available energy storage at the apparatus, or a minimum time period between successive transmissions or successive receptions of the apparatus. For instance, referring to FIG. 13, the EH class 1310 of the Rx UE 1304 may be defined by, mapped to, or otherwise associated with the minimum or default charging rate 1326 of the Rx UE, the maximum quantity of available energy storage 1328 at the Rx UE, and/or the minimum time period 1330 between successive transmissions or receptions at the Rx UE.

In one example, the time offset is indicated in a radio resource control configuration. For instance, referring to FIG. 13, the Rx UE 1304 may receive RRC configuration 1320 from the base station 1306 or the Tx UE 1302 indicating the time offset(s) 1316. In another example, the time offset is indicated in downlink control information. For instance, referring to FIG. 13, the Rx UE 1304 may receive DCI 1322 from the base station 1306 indicating the time offset(s) 1316.

At 1416, the Rx UE may transmit an EH indication in a PSFCH associated with the first resource. For example, 1416 may be performed by EH indication component 1648. For instance, referring to FIG. 13, the Tx UE 1302 may transmit sidelink data 1332 to the Rx UE 1304 in a configured or reserved Tx occasion (e.g., indicated in a configuration from the base station or autonomously determined). For instance, the Tx UE 1302 may transmit sidelink data 1332 to Rx UE 1304 in slot i in resource pool 600, 1000, 1100, 1150, 1200 or Tx occasion 904. If the Rx UE 1304 fails to successfully receive the sidelink data 1332, the Rx UE 1304 may transmit an EH indication 1334 in a PSFCH associated with the Tx occasion (e.g., in the PSFCH of slot i or Tx occasion 904) requesting or not requesting the Tx UE to apply the time offset(s) 1316 for a subsequent ReTx.

In one example, the EH indication is transmitted with HARQ feedback in a same resource block. For instance, referring to FIG. 13, the Rx UE 1304 may multiplex the EH indication 1334 in a same RB as HARQ feedback (e.g., in a same associated PRB as HARQ feedback 808 in FIG. 8) by utilizing a joint cyclic shift. For instance, when generating a baseband sequence (or other sequence) for a PSSCH transmission which utilizes a cyclic shift, the Rx UE may apply a different cyclic shift respectively for different bit combinations of HARQ-ACK and EH indications.

In one example, the EH indication is transmitted in a different resource block than HARQ feedback. For instance, referring to FIG. 13, the Rx UE 1304 may transmit the EH indication 1334 in a different RB than the HARQ feedback (e.g., in a different associated PRB than that of HARQ feedback 808 in FIG. 8), as opposed to the same RB.

In one example, a resource block for HARQ feedback is based on the EH indication. For instance, referring to FIG. 13, the Rx UE 1304 may not expressly transmit EH indication 1334 per se, but may impliedly provide the EH indication by shifting the RB which the Rx UE utilizes for HARQ-ACK. For instance, referring to the example of FIG. 8 where PSSCH 802 is mapped to resource 804 (e.g., PRBs) in PSFCH 806, the Rx UE may transmit HARQ feedback 808 in one of these associated PRBs when requesting utilization of default resource reservations 1002 and in a different one of these associated PRBs when requesting utilization of offset resource reservations 1004.

At 1418, the Rx UE receives sidelink data in a third resource at a time offset with respect to the second resource, wherein the time offset is based on the information (transmitted at 1402). For example, 1418 may be performed by sidelink data component 1646. In one example, the sidelink data is received in the third resource in response to the EH indication transmitted at 1416. For instance, referring to FIG. 13, in response to receiving the EH indication 1334, if the EH indication 1334 requested application of time offset(s) 1316, then the Tx UE 1302 may retransmit sidelink data 1332 to Rx UE 1304 in a resource (the third resource) offset in time (at time offset 1316) with respect to the configured or reserved ReTx occasion (the second resource) indicated in configuration 1318. For instance, the Tx UE 1302 may retransmit sidelink data 1332 to Rx UE 1304 in slot i+x+zₖ in resource pool 600, 1000, 1100, 1150, 1200, which is offset in time by zₖ slots with respect to the reserved ReTx resource, slot i+x. The time offset 1316 may be based on the information 1308 which the Rx UE 1304 provided indicating its capability or harvesting ambient energy (e.g., the EH class 1310). For instance, the Tx UE 1302 may apply the time offset 1316 in response to receiving information 1308 including EH class 1310 from the Rx UE.

In one example, the configuration received at 1404 indicates a fourth resource for another sidelink data retransmission, and in response to a difference in time between the fourth resource and the second resource being less than or equal to the time offset, the sidelink data is received in the third resource. For instance, referring to FIGS. 11A and 13, the configuration 1318 may schedule or activate configured or reserved ReTx occasions at slot i+x (the second resource in this example) and slot i+y (the fourth resource in this example), and if a difference in time between slot i+y and slot i+x is less than or equal to zₖ (i.e., (y−x)≤zₖ, or slot i+x+zₖ is the same as or later in time than slot i+y), the Tx UE 1302 may send the sidelink data retransmission in slot i+x+zₖ (the third resource in this example), and refrain from or skip sending the ReTx in slot i+y.

In one example, the configuration received at 1404 indicates the third resource for the sidelink data retransmission, and in response to a difference in time between the third resource and the second resource being greater than the time offset, the sidelink data is received in the third resource. For instance, referring to FIGS. 11B and 13, the configuration 1318 may schedule or activate configured or reserved ReTx occasions at slot i+x (the second resource in this example) and slot i+y (the third resource in this example), and a difference in time between slot i+y and slot i+x is greater than zₖ (i.e., (y−x)>zₖ, or slot i+x+zₖ is earlier in time than slot i+y), the Tx UE may send the sidelink data retransmission in slot i+y (the third resource), and refrain from or skip sending the ReTx in slot i+x+zₖ.

At 1420, in one example where the Rx UE receives sidelink data in the third resource (at 1418), the Rx UE may transmit an EH indication in a PSFCH associated with a fourth resource which is offset in time with respect to a fifth resource. For example, 1420 may be performed by EH indication component 1648. The configuration received at 1404 may further indicate the fifth resource for an initial sidelink data retransmission, the second resource (indicated in the configuration) may be for a subsequent sidelink data retransmission, and the sidelink data may be received in the third resource in response to the EH indication at 1420. For instance, referring to FIG. 13, the configuration 1318 may schedule or activate configured or reserved ReTx occasions at slot i+x (the fifth resource in this example) and slot i+y (the second resource in this example). Moreover, if the Rx UE 1304 fails to successfully receive the retransmission of the sidelink data 1332, the Rx UE 1304 may transmit EH indication 1336 in a PSFCH of slot i+x+zₖ (the fourth resource in this example, which is offset in time by zₖ slots with respect to the fifth resource in this example, slot i+x) requesting the Tx UE to apply the time offset(s) 1316 for another ReTx. Here, if the EH indication 1336 requested application of time offset(s) 1316, then the Tx UE 1302 may retransmit sidelink data 1332 to Rx UE 1304 in a resource (the third resource) offset in time (at time offset 1316) with respect to the next configured or reserved ReTx occasion (the second resource). For instance, the Tx UE 1302 may retransmit sidelink data 1332 to Rx UE 1304 in slot i+y+zₖ in resource pool 600, 1000, 1100, 1150, 1200, which is offset in time by zₖ slots with respect to the reserved ReTx resource, slot i+y.

In one example, an energy harvesting class of the apparatus or the time offset is associated with a resource pool including the first resource, the second resource, and the third resource. For instance, referring to FIG. 13, the Rx UE 1304 may receive configuration 1312 indicating resource pool 1314 including resources (e.g., slots, sub-channels, RBs, etc., such as slot i, slot i+x, slot i+x+zₖ, slot i+y, slot i+y+zₖ) which the Tx UE 1302 and Rx UE 1304 may apply for sidelink communication. The resource pool 1314 may be associated with the EH class 1310 of the Rx UE 1304. The resource pool 1314 may additionally or alternatively be associated with one or more time offsets 1316 (a single time offset zₖ or set of multiple time offsets zₖ, etc.).

In one example, an energy harvesting class of the apparatus is associated with a first time offset for transmissions and a second time offset for receptions, and the time offset is the second time offset. For instance, referring to FIGS. 12 and 13, different time offsets zₖ may be respectively configured (e.g., in configuration 1312) for transmission and reception in a same EH class (e.g., EH class 1310 of Rx UE 1304), including a time offset z_{k_tx} for transmissions (the first time offset at which exist the offset resource reservation 1204) and a time offset zₖ_xx for receptions (the second time offset at which exist the offset resource reservation 1206). In such case, where the Rx UE 1304 is the EH device, the time offset 1316 that the Tx UE 1302 applies for its sidelink communications may be configured to be the time offset z_{k_rx} for receptions (the second time offset at which exist the offset resource reservation 1206). In one example, an energy harvesting class of the apparatus is associated with a first time offset for transmissions and a second time offset for receptions, and the time offset is a maximum time offset out of the first time offset and the second time offset. For instance, referring to FIGS. 12 and 13, different time offsets zₖ may be respectively configured (e.g., in configuration 1312) for transmission and reception in a same EH class (e.g., EH class 1310 of Rx UE 1304), including a time offset z_{k_tx} for transmissions (the first time offset at which exist the offset resource reservation 1204) and a time offset z_{k_rx} for receptions (the second time offset at which exist the offset resource reservation 1206). In such case, where the Rx UE 1304 is the EH device, the time offset 1316 that the Tx UE 1302 applies for its sidelink communications may be configured to be the maximum quantity of slots (or other value) that the EH device would require to harvest sufficient energy for transmission or reception. For instance, as illustrated in FIG. 12, the maximum time offset (the time offset 1316) may be the time offset z_{k_tx} for transmissions (the first time offset at which exist the offset resource reservation 1204).

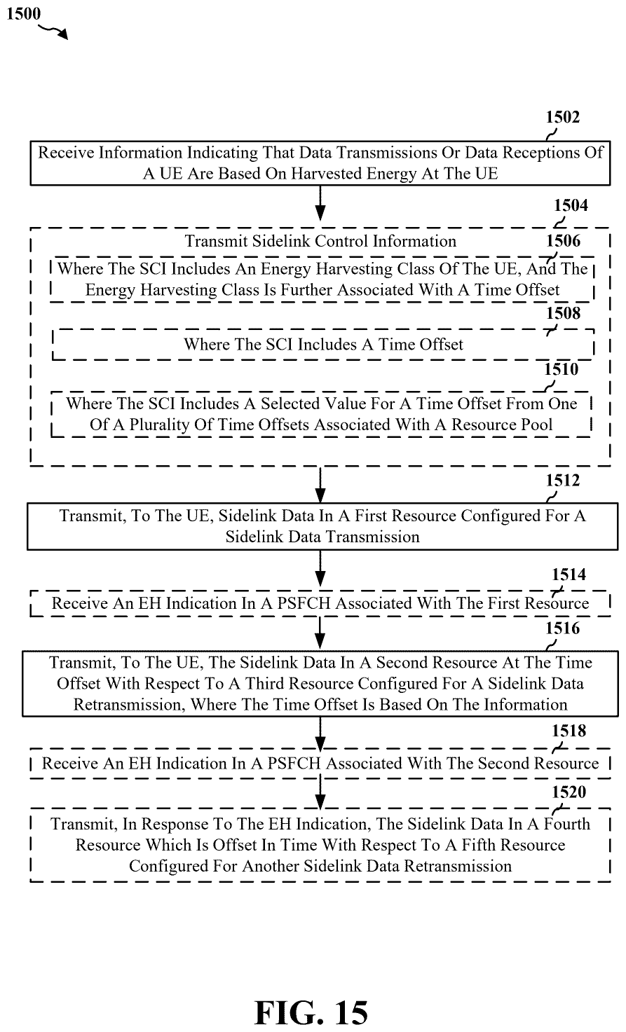

FIG. 15 is a flowchart 1500 of a method of wireless communication. The method may be performed by a Tx UE (e.g., the UE 104, 1302; the first wireless communication device 410; first UE 502; the apparatus 1602). Optional aspects are illustrated in dashed lines. The method allows a Tx UE, which communicates with an Rx UE that harvests energy for performing communications with other UEs (e.g., the Rx UE is an EH device), to provide sidelink data retransmissions with an increased or lengthened period between reserved or configured resources for sidelink data transmissions and retransmissions by a time offset.

At 1502, the Tx UE receives information indicating that data transmissions or data receptions of a UE are based on harvested energy at the UE. For example, 1502 may be performed by information component 1640. For instance, referring to FIG. 13, the Tx UE 1302 may receive information 1308 including EH class 1310 of the Rx UE 1304. The information 1308 (e.g., the EH class 1310) may indicate that data transmissions or data receptions of the Rx UE 1304 are based on harvested energy at the Rx UE (e.g., harvested energy 508 in FIG. 5).

At 1504, the Tx UE may transmit sidelink control information. For example, 1504 may be performed by SCI component 1644. For instance, referring to FIG. 13, the Rx UE 1304 may receive SCI 1324 from Tx UE 1302. In one example, at 1506, the SCI may include an energy harvesting class of the UE, where the energy harvesting class is further associated with a time offset. For instance, referring to FIG. 13, the SCI 1324 may include the EH class 1310 of the Rx UE 1304, and the EH class 1310 may be associated with the time offset 1316 (e.g., time offset zₖ for EH class k). In another example, at 1508, the SCI may include a time offset. For instance, referring to FIG. 13, the SCI 1324 may directly indicate the time offset 1316 (e.g., expressly, rather than via an EH class). In another example, at 1510, the SCI may include a selected value for a time offset from one of a plurality of time offsets associated with a resource pool. For instance, referring to FIG. 13, the Tx UE 1302 may select a value for the time offset(s) 1316, for example, from a set of multiple configured time offsets zₖ per EH class k per resource pool, from an agreed list of potential values between Tx UE 1302 and Rx UE 1304 (e.g., during an RRC connection), from values updated over time using a layer 1, layer 2, or layer 3 indication, or from values in a codebook defined between the UEs. In such case, the Tx UE 1302 may indicate the selected time offset in SCI 1324 according to either of the foregoing examples (e.g., via the EH class 1310 or the time offset 1316 directly).

At 1512, the Tx UE transmits, to the UE, sidelink data in a first resource configured for a sidelink data transmission. For example, 1512 may be performed by sidelink data component 1646. For instance, referring to FIG. 13, the Tx UE may the Tx UE 1302 may transmit sidelink data 1332 to the Rx UE 1304 in a configured or reserved Tx occasion (e.g., indicated in a configuration from the base station or autonomously determined). For instance, the Tx UE 1302 may transmit sidelink data 1332 to Rx UE 1304 in slot i (the first resource) in resource pool 600, 1000, 1100, 1150, 1200 or Tx occasion 904.

At 1514, the Tx UE may receive an EH indication in a PSFCH associated with the first resource. For example, 1514 may be performed by EH indication component 1648. For instance, referring to FIG. 13, if the Rx UE 1304 fails to successfully receive the sidelink data 1332, the Tx UE 1302 may receive EH indication 1334 from Rx UE 1304 in a PSFCH associated with the Tx occasion (e.g., in the PSFCH of slot i or Tx occasion 904, which is the first resource in this example) requesting or not requesting the Tx UE to apply the time offset(s) 1316 for a subsequent ReTx.

At 1516, the Tx UE transmits, to the UE, the sidelink data in a second resource at the time offset with respect to a third resource configured for a sidelink data retransmission, where the time offset is based on the information received at 1502. For example, 1516 may be performed by sidelink data component 1646. In one example, the sidelink data is transmitted in the second resource in response to the EH indication received at 1514. For instance, referring to FIG. 13, in response to receiving the EH indication 1334, if the EH indication 1334 requested application of time offset(s) 1316, then the Tx UE 1302 may retransmit sidelink data 1332 to Rx UE 1304 in a resource (the second resource) offset in time (at time offset 1316) with respect to the configured or reserved ReTx occasion (the third resource) indicated in configuration 1318. For instance, the Tx UE 1302 may retransmit sidelink data 1332 to Rx UE 1304 in slot i+x+zₖ in resource pool 600, 1000, 1100, 1150, 1200, which is offset in time by zₖ slots with respect to the reserved ReTx resource, slot i+x. The time offset 1316 may be based on the information 1308 which the Rx UE 1304 provided indicating its capability or harvesting ambient energy (e.g., the EH class 1310). For instance, the Tx UE 1302 may apply the time offset 1316 in response to receiving information 1308 including EH class 1310 from the Rx UE.

At 1518, the Tx UE may receive an EH indication in a PSFCH associated with the second resource. For example, 1518 may be performed by EH indication component 1648. Moreover, at 1520, the Tx UE may transmit, in response to the EH indication received at 1518, the sidelink data in a fourth resource which is offset in time with respect to a fifth resource configured for another sidelink data retransmission. For example, 1520 may be performed by sidelink data component 1646. For instance, referring to FIG. 13, the configuration 1318 may schedule or activate configured or reserved ReTx occasions at slot i+x (the third resource in this example) and slot i+y (the fifth resource in this example). Moreover, if the Rx UE 1304 fails to successfully receive the retransmission of the sidelink data 1332, the Tx UE 1302 may receive EH indication 1336 from Rx UE 1304 in a PSFCH of slot i+x+zₖ (the second resource in this example, which is offset in time by zₖ slots with respect to the third resource in this example, slot i+x) requesting the Tx UE to apply the time offset(s) 1316 for another ReTx. Here, if the EH indication 1336 requested application of time offset(s) 1316, then the Tx UE 1302 may retransmit sidelink data 1332 to Rx UE 1304 in a resource (the fourth resource) offset in time (at time offset 1316) with respect to the next configured or reserved ReTx occasion (the fifth resource). For instance, the Tx UE 1302 may retransmit sidelink data 1332 to Rx UE 1304 in slot i+y+zₖ in resource pool 600, 1000, 1100, 1150, 1200, which is offset in time by zₖ slots with respect to the reserved ReTx resource, slot i+y.

In one example, an energy harvesting class of the UE is associated with a first time offset for transmissions and a second time offset for receptions, and the time offset may be the second time offset. For instance, referring to FIGS. 12 and 13, different time offsets zₖ may be respectively configured (e.g., in configuration 1312) for transmission and reception in a same EH class (e.g., EH class 1310 of Rx UE 1304), including a time offset z_{k_tx} for transmissions (the first time offset at which exist the offset resource reservation 1204) and a time offset z_{k_rx} for receptions (the second time offset at which exist the offset resource reservation 1206). In such case, where the Rx UE 1304 is the EH device, the time offset 1316 that the Tx UE 1302 applies for its sidelink communications may be configured to be the time offset z_{k_rx} for receptions (the second time offset at which exist the offset resource reservation 1206).

In one example, an energy harvesting class of the UE is associated with a first time offset for transmissions and a second time offset for receptions, and the time offset may be a maximum time offset out of the first time offset and the second time offset. For instance, referring to FIGS. 12 and 13, different time offsets zₖ may be respectively configured (e.g., in configuration 1312) for transmission and reception in a same EH class (e.g., EH class 1310 of Rx UE 1304), including a time offset z_{k_tx} for transmissions (the first time offset at which exist the offset resource reservation 1204) and a time offset z_{k_rx} for receptions (the second time offset at which exist the offset resource reservation 1206). In such case, where the Rx UE 1304 is the EH device, the time offset 1316 that the Tx UE 1302 applies for its sidelink communications may be configured to be the maximum quantity of slots (or other value) that the EH device would require to harvest sufficient energy for transmission or reception. For instance, as illustrated in FIG. 12, the maximum time offset (the time offset 1316) may be the time offset z_{k_tx} for transmissions (the first time offset at which exist the offset resource reservation 1204).

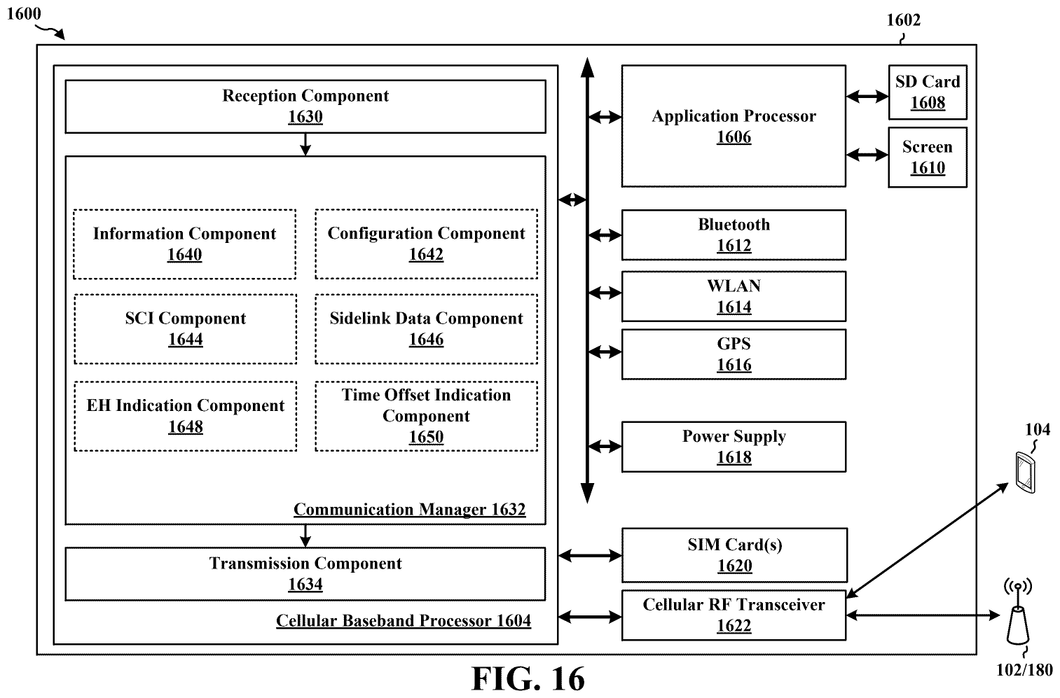

FIG. 16 is a diagram 1600 illustrating an example of a hardware implementation for an apparatus 1602 that may be used to implement the examples described above. The apparatus 1602 may be a UE and may include a cellular baseband processor 1604 (also referred to as a modem) coupled to a cellular RF transceiver 1622 and one or more subscriber identity modules (SIM) cards 1620, an application processor 1606 coupled to a secure digital (SD) card 1608 and a screen 1610, a Bluetooth module 1612, a wireless local area network (WLAN) module 1614, a Global Positioning System (GPS) module 1616, and a power supply 1618. The cellular baseband processor 1604 may communicate through the cellular RF transceiver 1622 with the UE 104 and/or BS 102/180. The cellular baseband processor 1604 may include a computer-readable medium/memory. The computer-readable medium/memory may be non-transitory. The cellular baseband processor 1604 may be responsible for general processing, including the execution of software stored on the computer-readable medium/memory. The software, when executed by the cellular baseband processor 1604, causes the cellular baseband processor 1604 to perform the various functions described supra. The computer-readable medium/memory may also be used for storing data that is manipulated by the cellular baseband processor 1604 when executing software. The cellular baseband processor 1604 may further include a reception component 1630, a communication manager 1632, and a transmission component 1634. The communication manager 1632 may include the one or more illustrated components. The components within the communication manager 1632 may be stored in the computer-readable medium/memory and/or configured as hardware within the cellular baseband processor 1604. The cellular baseband processor 1604 may be a component of the device 410, 450 and may include the memory 460 and/or at least one of the TX processor 416, 468, the RX processor 456, 470, and the controller/processor 459, 475. In one configuration, the apparatus 1602 may be a modem chip and include just the baseband processor 1604, and in another configuration, the apparatus 1602 may be the entire UE (e.g., see 450 of FIG. 4) and include the aforediscussed additional modules of the apparatus 1602.

The communication manager 1632 may include an information component 1640 that is configured to transmit information indicating that data transmissions or data receptions of a UE are based on harvested energy at the UE, e.g., as described in connection with 1402. The information component 1640 may be further configured to receive information indicating that data transmissions or data receptions of a UE are based on harvested energy at the UE, e.g., as described in connection with 1502.

The communication manager 1632 may include a configuration component 1642 that is configured to receive a configuration indicating a first resource for a sidelink data transmission and a second resource for a sidelink data retransmission, e.g., as described in connection with 1404.

The communication manager 1632 may include a time offset indication component 1650 that is configured to transmit an indication of a selected value for a time offset from one of a plurality of time offsets, e.g., as described in connection with 1406.

The communication manager 1632 may include an SCI component 1644 that is configured to receive SCI, e.g., as described in connection with 1408, 1410, 1412, and 1414. The SCI component 1644 may be further configured to transmit SCI, e.g., as described in connection with 1504, 1506, 1508, and 1510.

The communication manager 1632 may include a sidelink data component 1646 that is configured to transmit, to the UE, sidelink data in a first resource configured for a sidelink data transmission, e.g., as described in connection with 1512. The sidelink data component 1646 may be further configured to transmit, to the UE, the sidelink data in a second resource at the time offset with respect to a third resource configured for a sidelink data retransmission, where the time offset is based on the information, e.g., as described in connection with 1516.

The communication manager 1632 may include an EH indication component 1648 that is configured to transmit an EH indication in a PSFCH associated with the first resource, e.g., as described in connection with 1416. The EH indication component 1648 may be further configured to transmit an EH indication in a PSFCH associated with a fourth resource which is offset in time with respect to a fifth resource, e.g., as described in connection with 1420.

The EH indication component 1648 may be further configured to receive an EH indication in a PSFCH associated with the first resource, e.g., as described in connection with 1514. The EH indication component 1648 may be further configured to receive an EH indication in a PSFCH associated with the second resource, e.g., as described in connection with 1518.

The sidelink data component 1646 may be further configured to receive the sidelink data in a third resource at the time offset with respect to the second resource, where the time offset is based on the information, e.g., as described in connection with 1418.

The sidelink data component 1646 may be further configured to transmit, in response to the EH indication, the sidelink data in a fourth resource which is offset in time with respect to a fifth resource configured for another sidelink data retransmission, e.g., as described in connection with 1520.

The apparatus may include additional components that perform each of the blocks of the algorithm in the aforementioned flowcharts of FIGS. 14 and 15. As such, each block in the aforementioned flowcharts of FIGS. 14 and 15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1602, and in particular the cellular baseband processor 1604, may include means for receiving a configuration indicating a first resource for a sidelink data transmission and a second resource for a sidelink data retransmission; means for transmitting information indicating that data transmissions or data receptions of the apparatus are based on harvested energy at the apparatus; and where the means for receiving is further configured to receive sidelink data in a third resource at a time offset with respect to the second resource, wherein the time offset is based on the information.

In one configuration, the time offset is associated with an energy harvesting class of the apparatus.

In one configuration, an energy harvesting class of the apparatus is associated with a plurality of time offsets including the time offset.

In one configuration, an energy harvesting class of the apparatus indicates a minimum or default charging rate of the apparatus, a maximum quantity of available energy storage at the apparatus, or a minimum time period between successive transmissions or successive receptions of the apparatus.

In one configuration, the means for receiving may be further configured to receive sidelink control information including an energy harvesting class of the apparatus,
wherein the energy harvesting class is further associated with the time offset.

In one configuration, the time offset is indicated in a radio resource control configuration.

In one configuration, the time offset is indicated in downlink control information.

In one configuration, the means for receiving may be further configured to receive sidelink control information including the time offset.

In one configuration, the means for transmitting may be further configured to transmit an energy harvesting (EH) indication in a physical sidelink feedback channel (PSFCH) associated with the first resource, wherein the sidelink data is received in the third resource in response to the EH indication.

In one configuration, the EH indication is transmitted with hybrid automatic repeat request (HARQ) feedback in a same resource block.

In one configuration, the EH indication is transmitted in a different resource block than hybrid automatic repeat request (HARQ) feedback.

In one configuration, a resource block for hybrid automatic repeat request (HARQ) feedback is based on the EH indication.

In one configuration, the means for transmitting may be further configured to transmit an indication of a selected value for the time offset from one of a plurality of time offsets.

In one configuration, the configuration indicates a fourth resource for another sidelink data retransmission, and in response to a difference in time between the fourth resource and the second resource being less than or equal to the time offset, the sidelink data is received in the third resource.

In one configuration, the configuration indicates the third resource for the sidelink data retransmission, and in response to a difference in time between the third resource and the second resource being greater than the time offset, the sidelink data is received in the third resource.

In one configuration, the means for transmitting may be further configured to transmit an energy harvesting (EH) indication in a physical sidelink feedback channel (PSFCH) associated with a fourth resource which is offset in time with respect to a fifth resource; wherein the configuration further indicates the fifth resource for an initial sidelink data retransmission, the second resource is for a subsequent sidelink data retransmission, and the sidelink data is received in the third resource in response to the EH indication.

In one configuration, an energy harvesting class of the apparatus or the time offset is associated with a resource pool including the first resource, the second resource, and the third resource.

In one configuration, the means for receiving may be further configured to receive sidelink control information including a selected value for the time offset from one of a plurality of time offsets associated with the resource pool.

In one configuration, an energy harvesting class of the apparatus is associated with a first time offset for transmissions and a second time offset for receptions, and the time offset is the second time offset.

In one configuration, an energy harvesting class of the apparatus is associated with a first time offset for transmissions and a second time offset for receptions, and the time offset is a maximum time offset out of the first time offset and the second time offset.

In one configuration, the apparatus 1602, and in particular the cellular baseband processor 1604, may include means for receiving information indicating that data transmissions or data receptions of a user equipment (UE) are based on harvested energy at the UE; means for transmitting, to the UE, sidelink data in a first resource configured for a sidelink data transmission; and wherein the means for transmitting is further configured to transmit, to the UE, the sidelink data in a second resource at a time offset with respect to a third resource configured for a sidelink data retransmission, wherein the time offset is based on the information.

In one configuration, the means for transmitting may be further configured to transmit sidelink control information including an energy harvesting class of the UE, wherein the energy harvesting class is further associated with the time offset.

In one configuration, the means for transmitting may be further configured to transmit sidelink control information including the time offset.

In one configuration, the means for receiving may be further configured to receive an energy harvesting (EH) indication in a physical sidelink feedback channel (PSFCH) associated with the first resource, wherein the sidelink data is transmitted in the second resource in response to the EH indication.

In one configuration, the means for receiving may be further configured to receive an energy harvesting (EH) indication in a physical sidelink feedback channel (PSFCH) associated with the second resource; and transmit, in response to the EH indication, the sidelink data in a fourth resource which is offset in time with respect to a fifth resource configured for another sidelink data retransmission.

In one configuration, the means for transmitting may be further configured to transmit sidelink control information including a selected value for the time offset from one of a plurality of time offsets associated with a resource pool.

In one configuration, an energy harvesting class of the UE is associated with a first time offset for transmissions and a second time offset for receptions, and the time offset is the second time offset.

In one configuration, an energy harvesting class of the UE is associated with a first time offset for transmissions and a second time offset for receptions, and the time offset is a maximum time offset out of the first time offset and the second time offset.

The aforementioned means may be one or more of the aforementioned components of the apparatus 1602 configured to perform the functions recited by the aforementioned means. As described supra, the apparatus 1602 may include the TX Processor 416, 468, the RX Processor 456, 470, and the controller/processor 459, 475. As such, in one configuration, the aforementioned means may be the TX Processor 416, 468, the RX Processor 456, 470, and the controller/processor 459, 475 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following embodiments are illustrative only and may be combined with aspects of other embodiments or teachings described herein, without limitation.

Example 1 is an apparatus for wireless communication, comprising: a processor; memory coupled with the processor; and instructions stored in the memory and operable, when executed by the processor, to cause the apparatus to: receive a configuration indicating a first resource for a sidelink data transmission and a second resource for a sidelink data retransmission; transmit information indicating that data transmissions or data receptions of the apparatus are based on harvested energy at the apparatus; and receive sidelink data in a third resource at a time offset with respect to the second resource, wherein the time offset is based on the information.

Example 2 is the apparatus of Example 1, wherein the time offset is associated with an energy harvesting class of the apparatus.

Example 3 is the apparatus of Examples 1 or 2, wherein an energy harvesting class of the apparatus is associated with a plurality of time offsets including the time offset.

Example 4 is the apparatus of any of Examples 1 to 3, wherein an energy harvesting class of the apparatus indicates a minimum or default charging rate of the apparatus, a maximum quantity of available energy storage at the apparatus, or a minimum time period between successive transmissions or successive receptions of the apparatus.

Example 5 is the apparatus of any of Examples 1 to 4, wherein the instructions, when executed by the processor, further cause the apparatus to: receive sidelink control information including an energy harvesting class of the apparatus, wherein the energy harvesting class is further associated with the time offset.

Example 6 is the apparatus of any of Examples 1 to 5, wherein the time offset is indicated in a radio resource control configuration.

Example 7 is the apparatus of any of Examples 1 to 6, wherein the time offset is indicated in downlink control information.

Example 8 is the apparatus of any of Examples 1 to 4, 6 or 7, wherein the instructions, when executed by the processor, further cause the apparatus to: receive sidelink control information including the time offset.

Example 9 is the apparatus of any of Examples 1 to 8, wherein the instructions, when executed by the processor, further cause the apparatus to: transmit an energy harvesting (EH) indication in a physical sidelink feedback channel (PSFCH) associated with the first resource, wherein the sidelink data is received in the third resource in response to the EH indication.

Example 10 is the apparatus of Example 9, wherein the EH indication is transmitted with hybrid automatic repeat request (HARQ) feedback in a same resource block.

Example 11 is the apparatus of Example 9, wherein the EH indication is transmitted in a different resource block than hybrid automatic repeat request (HARQ) feedback.

Example 12 is the apparatus of Example 9, wherein a resource block for hybrid automatic repeat request (HARQ) feedback is based on the EH indication.

Example 13 is the apparatus of any of Examples 1 to 12, wherein the instructions, when executed by the processor, further cause the apparatus to: transmit an indication of a selected value for the time offset from one of a plurality of time offsets.

Example 14 is the apparatus of any of Examples 1 to 13, wherein the configuration indicates a fourth resource for another sidelink data retransmission, and in response to a difference in time between the fourth resource and the second resource being less than or equal to the time offset, the sidelink data is received in the third resource.

Example 15 is the apparatus of any of Examples 1 to 13, wherein the configuration indicates the third resource for the sidelink data retransmission, and in response to a difference in time between the third resource and the second resource being greater than the time offset, the sidelink data is received in the third resource.

Example 16 is the apparatus of any of Examples 1 to 15, wherein the instructions, when executed by the processor, further cause the apparatus to: transmit an energy harvesting (EH) indication in a physical sidelink feedback channel (PSFCH) associated with a fourth resource which is offset in time with respect to a fifth resource; wherein the configuration further indicates the fifth resource for an initial sidelink data retransmission, the second resource is for a subsequent sidelink data retransmission, and the sidelink data is received in the third resource in response to the EH indication.

Example 17 is the apparatus of any of Examples 1 to 16, wherein an energy harvesting class of the apparatus or the time offset is associated with a resource pool including the first resource, the second resource, and the third resource.

Example 18 is the apparatus of Example 17, wherein the instructions, when executed by the processor, further cause the apparatus to: receive sidelink control information including a selected value for the time offset from one of a plurality of time offsets associated with the resource pool.

Example 19 is the apparatus of any of Examples 1 to 18, wherein an energy harvesting class of the apparatus is associated with a first time offset for transmissions and a second time offset for receptions, and the time offset is the second time offset.

Example 20 is the apparatus of any of Examples 1 to 18, wherein an energy harvesting class of the apparatus is associated with a first time offset for transmissions and a second time offset for receptions, and the time offset is a maximum time offset out of the first time offset and the second time offset.

Example 21 is an apparatus for wireless communication, comprising: a processor; memory coupled with the processor; and instructions stored in the memory and operable, when executed by the processor, to cause the apparatus to: receive information indicating that data transmissions or data receptions of a user equipment (UE) are based on harvested energy at the UE; transmit, to the UE, sidelink data in a first resource configured for a sidelink data transmission; and transmit, to the UE, the sidelink data in a second resource at a time offset with respect to a third resource configured for a sidelink data retransmission, wherein the time offset is based on the information.

Example 22 is the apparatus of Example 21, wherein the instructions, when executed by the processor, further cause the apparatus to: transmit sidelink control information including an energy harvesting class of the UE, wherein the energy harvesting class is further associated with the time offset.

Example 23 is the apparatus of Example 21, wherein the instructions, when executed by the processor, further cause the apparatus to: transmit sidelink control information including the time offset.

Example 24 is the apparatus of any of Examples 21 to 23, wherein the instructions, when executed by the processor, further cause the apparatus to: receive an energy harvesting (EH) indication in a physical sidelink feedback channel (PSFCH) associated with the first resource, wherein the sidelink data is transmitted in the second resource in response to the EH indication.

Example 25 is the apparatus of any of Examples 21 to 24, wherein the instructions, when executed by the processor, further cause the apparatus to: receive an energy harvesting (EH) indication in a physical sidelink feedback channel (PSFCH) associated with the second resource; and transmit, in response to the EH indication, the sidelink data in a fourth resource which is offset in time with respect to a fifth resource configured for another sidelink data retransmission.

Example 26 is the apparatus of any of Examples 21 to 25, wherein the instructions, when executed by the processor, further cause the apparatus to: transmit sidelink control information including a selected value for the time offset from one of a plurality of time offsets associated with a resource pool.

Example 27 is the apparatus of any of Examples 21 to 26, wherein an energy harvesting class of the UE is associated with a first time offset for transmissions and a second time offset for receptions, and the time offset is the second time offset.

Example 28 is the apparatus of any of Examples 21 to 26, wherein an energy harvesting class of the UE is associated with a first time offset for transmissions and a second time offset for receptions, and the time offset is a maximum time offset out of the first time offset and the second time offset.

Example 29 is a method of wireless communication at a user equipment (UE), comprising: receiving a configuration indicating a first resource for a sidelink data transmission and a second resource for a sidelink data retransmission; transmitting information indicating that data transmissions or data receptions of the apparatus are based on harvested energy at the UE; receiving sidelink data in a third resource at a time offset with respect to the second resource, wherein the time offset is based on the information.

Example 30 is a method of wireless communication at a first user equipment (UE), comprising: receiving information indicating that data transmissions or data receptions of a second UE are based on harvested energy at the second UE; transmitting sidelink data in a first resource configured for a sidelink data transmission; and transmitting the sidelink data in a second resource at a time offset with respect to a third resource configured for a sidelink data retransmission, wherein the time offset is based on the information.

What is claimed is:

1. An apparatus for wireless communication, comprising:
a processor;
memory coupled with the processor; and
instructions stored in the memory and operable, when executed by the processor, to cause the apparatus to:
receive a configuration indicating a first resource for a sidelink data transmission and a second resource for a sidelink data retransmission;
transmit information indicating that data transmissions or data receptions of the apparatus are based on harvested energy at the apparatus; and
receive sidelink data in a third resource at a time offset with respect to the second resource, wherein the time offset is based on the information.

2. The apparatus of claim 1, wherein the time offset is associated with an energy harvesting class of the apparatus.

3. The apparatus of claim 1, wherein an energy harvesting class of the apparatus is associated with a plurality of time offsets including the time offset.

4. The apparatus of claim 1, wherein an energy harvesting class of the apparatus indicates a minimum charging rate and a minimum discharging rate of the apparatus, a default charging rate and a default discharging rate of the apparatus, a maximum quantity of available energy storage at the apparatus, or a minimum time period between successive transmissions or successive receptions of the apparatus.

5. The apparatus of claim 1, wherein the instructions, when executed by the processor, further cause the apparatus to:
receive sidelink control information including an energy harvesting class of the apparatus, wherein the energy harvesting class is further associated with the time offset.

6. The apparatus of claim 1, wherein the time offset is indicated in a radio resource control configuration.

7. The apparatus of claim 1, wherein the time offset is indicated in downlink control information.

8. The apparatus of claim 1, wherein the instructions, when executed by the processor, further cause the apparatus to:
receive sidelink control information including the time offset.

9. The apparatus of claim 1, wherein the instructions, when executed by the processor, further cause the apparatus to:
transmit an energy harvesting (EH) indication in a physical sidelink feedback channel (PSFCH) associated with the first resource, wherein the sidelink data is received in the third resource in response to the EH indication.

10. The apparatus of claim 9, wherein the EH indication is transmitted with hybrid automatic repeat request (HARQ) feedback in a same resource block.

11. The apparatus of claim 9, wherein the EH indication is transmitted in a different resource block than hybrid automatic repeat request (HARQ) feedback.

12. The apparatus of claim 9, wherein a resource block for hybrid automatic repeat request (HARQ) feedback is based on the EH indication.

13. The apparatus of claim 1, wherein the instructions, when executed by the processor, further cause the apparatus to:
transmit an indication of a selected value for the time offset from one of a plurality of time offsets.

14. The apparatus of claim 1, wherein the configuration indicates a fourth resource for another sidelink data retransmission, and in response to a difference in time between the fourth resource and the second resource being less than or equal to the time offset, the sidelink data is received in the third resource.

15. The apparatus of claim 1, wherein the configuration indicates the third resource for the sidelink data retransmission, and in response to a difference in time between the third resource and the second resource being greater than the time offset, the sidelink data is received in the third resource.

16. The apparatus of claim 1, wherein the instructions, when executed by the processor, further cause the apparatus to:
transmit an energy harvesting (EH) indication in a physical sidelink feedback channel (PSFCH) associated with a fourth resource which is offset in time with respect to a fifth resource;
wherein the configuration further indicates the fifth resource for an initial sidelink data retransmission, the second resource is for a subsequent sidelink data retransmission, and the sidelink data is received in the third resource in response to the EH indication.

17. The apparatus of claim 1, wherein an energy harvesting class of the apparatus or the time offset is associated with a resource pool including the first resource, the second resource, and the third resource.

18. The apparatus of claim 17, wherein the instructions, when executed by the processor, further cause the apparatus to:
receive sidelink control information including a selected value for the time offset from one of a plurality of time offsets associated with the resource pool.

19. The apparatus of claim 1, wherein an energy harvesting class of the apparatus is associated with a first time offset for transmissions and a second time offset for receptions, and the time offset is the second time offset.

20. The apparatus of claim 1, wherein an energy harvesting class of the apparatus is associated with a first time offset for transmissions and a second time offset for receptions, and the time offset is a maximum time offset out of the first time offset and the second time offset.

21. An apparatus for wireless communication, comprising:
a processor;
memory coupled with the processor; and
instructions stored in the memory and operable, when executed by the processor, to cause the apparatus to:
receive information indicating that data transmissions or data receptions of a user equipment (UE) are based on harvested energy at the UE;
transmit, to the UE, sidelink data in a first resource configured for a sidelink data transmission; and
transmit, to the UE, the sidelink data in a second resource at a time offset with respect to a third resource configured for a sidelink data retransmission,
wherein the time offset is based on the information.

22. The apparatus of claim 21, wherein the instructions, when executed by the processor, further cause the apparatus to:
transmit sidelink control information including an energy harvesting class of the UE, wherein the energy harvesting class is further associated with the time offset.

23. The apparatus of claim 21, wherein the instructions, when executed by the processor, further cause the apparatus to:
transmit sidelink control information including the time offset.

24. The apparatus of claim 21, wherein the instructions, when executed by the processor, further cause the apparatus to:
receive an energy harvesting (EH) indication in a physical sidelink feedback channel (PSFCH) associated with the first resource, wherein the sidelink data is transmitted in the second resource in response to the EH indication.

25. The apparatus of claim 21, wherein the instructions, when executed by the processor, further cause the apparatus to:
receive an energy harvesting (EH) indication in a physical sidelink feedback channel (PSFCH) associated with the second resource; and
transmit, in response to the EH indication, the sidelink data in a fourth resource which is offset in time with respect to a fifth resource configured for another sidelink data retransmission.

26. The apparatus of claim 21, wherein the instructions, when executed by the processor, further cause the apparatus to:
transmit sidelink control information including a selected value for the time offset from one of a plurality of time offsets associated with a resource pool.

27. The apparatus of claim 21, wherein an energy harvesting class of the UE is associated with a first time offset for transmissions and a second time offset for receptions, and the time offset is the second time offset.

28. The apparatus of claim 21, wherein an energy harvesting class of the UE is associated with a first time offset for transmissions and a second time offset for receptions, and the time offset is a maximum time offset out of the first time offset and the second time offset.

29. A method of wireless communication at a user equipment (UE), comprising:
receiving a configuration indicating a first resource for a sidelink data transmission and a second resource for a sidelink data retransmission;
transmitting information indicating that data transmissions or data receptions of the UE are based on harvested energy at the UE; and
receiving sidelink data in a third resource at a time offset with respect to the second resource, wherein the time offset is based on the information.

30. A method of wireless communication at a first user equipment (UE), comprising:
receiving information indicating that data transmissions or data receptions of a second UE are based on harvested energy at the second UE;
transmitting sidelink data in a first resource configured for a sidelink data transmission; and
transmitting the sidelink data in a second resource at a time offset with respect to a third resource configured for a sidelink data retransmission, wherein the time offset is based on the information.
